(19) United States
(12) Patent Application Publication
(10) Pub. No.: US 2025/0189643 A1
(43) Pub. Date: Jun. 12, 2025

(54) NONLINEAR ULTRASOUND IMAGING OF ACOUSTIC BIOMOLECULES USING CODED EXCITATIONS

(71) Applicant: California Institute of Technology, Pasadena, CA (US)

(72) Inventors: Rohit Nayak, Pasadena, CA (US); Mikhail G. Shapiro, Los Angeles, CA (US)

(21) Appl. No.: 18/977,594

(22) Filed: Dec. 11, 2024

Related U.S. Application Data
(60) Provisional application No. 63/608,742, filed on Dec. 11, 2023.

(51) Int. Cl. G01S 7/52; G01S 15/89

(52) U.S. Cl. CPC G01S 7/52039; G01S 15/8927; G01S 15/8959

(57) ABSTRACT

Nonlinear ultrasound imaging techniques that send ultrasound transmissions with multiple frequency or phase cycles for exciting and imaging nonlinear scatterers such as acoustic biomolecules.

### CROSS-REFERENCES TO RELATED APPLICATION

This application claims priority to and benefit of U.S. Provisional Patent Application No. 63/608,742, filed on Dec. 11, 2023, which is hereby incorporated by reference in its entirety and for all purposes.

### FEDERALLY SPONSORED RESEARCH OR DEVELOPMENT

This invention was made with government support under Grant No(s). EB018975 & NS120828 awarded by the National Institutes of Health. The government has certain rights in the invention.

### FIELD

Certain aspects generally pertain to ultrasound imaging, and more specifically, to non-linear ultrasound imaging techniques that can be used to image acoustic biomolecules.

### BACKGROUND

Ultrasound imaging is among the most widely used non-invasive imaging modalities in biomedicine due to its ability to visualize biological tissues with high spatial and temporal resolution, and due to its safety, cost efficiency, and ease of use. The development of micro- and nanoscale acoustic biomolecules as contrast agents has broadened the capability of ultrasound imaging for use at the molecular and cellular level. Most particularly, gas-filled protein nanostructures known as gas vesicles (GVs) provide unique capability to ultrasound imaging in visualizing cellular functions in vivo and in vitro.

### SUMMARY

Techniques disclosed herein may be practiced with a processor-implemented method, a system comprising one or more processors and one or more processor-readable media, and/or one or more non-transitory processor-readable media.

Certain embodiments pertain to ultrasound imaging systems. In some embodiments, an ultrasound imaging system includes an arrangement of transducer elements (e.g., an ultrasound probe) and a plurality of apertures of different sets of transducer elements in the arrangement of transducer elements. Each transducer element of each aperture is configured to generate an acoustic wave when activated by a transmission signal having a plurality of cycles. The acoustic waves generated by each set of transducer elements of each aperture form an acoustic beam along an axis. In certain examples, the acoustic beam may be a Bessel beam, a parabolic beam, a xAM beam, or a uAM beam.

Certain embodiments pertain to ultrasound imaging methods that receive a transmission signal having a plurality of frequency cycles or phase cycles. These methods also cause activation of apertures of different sets of transducer elements in an arrangement of transducer elements to generate acoustic waves based on the transmission signal to form an acoustic beam at different locations across a field-of-view.

Certain embodiments pertain to ultrasound imaging methods that send a transmission signal having a plurality of frequency cycles or phase cycles to an arrangement of transducer elements. These ultrasound imaging methods also cause activation of apertures of different sets of transducer elements in an arrangement of transducer elements to generate acoustic waves based on the transmission signal to form an acoustic beam at different locations across a field-of-view. These ultrasound imaging methods also receive a received signal from the arrangement of transducer elements with backscatter echo data induced by the acoustic waves and generate an image of nonlinear scatterers in the field-of-view based on the received signal.

Certain embodiments pertain to ultrasound imaging methods that cause activation of apertures of different sets of transducer elements in an arrangement of transducer elements to generate acoustic waves forming a Bessel beam swept to different locations across a field-of-view. In some cases, the activation of the apertures comprises communicating a transmission signal with a plurality of frequency cycles or phase cycles to the arrangement of transducer elements.

These and other features are described in more detail below with reference to the associated drawings.

### BRIEF DESCRIPTION OF THE DRAWINGS

FIG. 1A is a graph depicting an example of a cross-amplitude (xAM) ultrasound transmission measured using a hydrophone of a single cycle at 15.625 MHz center frequency, according to an embodiment.

FIG. 1B is a graph depicting an example of cross-amplitude (xAM) ultrasound transmission measured using a hydrophone of a twenty-six (26) cycle chirp with broadband frequency sweep at 12 to 24 Mhz, according to an embodiment.

FIG. 2A is a graph depicting a transmission signal having one (1) cycle at a frequency of 15.625 MHz and a corresponding received signal, according to an embodiment.

FIG. 2B is a graph depicting a transmission signal having six (6) cycles at a frequency of 15.625 MHz and a corresponding received signal, according to an embodiment.

FIG. 2C is a graph depicting a transmission signal having thirteen (13) cycles at a frequency of 15.625 MHz and a corresponding received signal, according to an embodiment.

FIG. 2D is a graph depicting a transmission signal having twenty (20) cycles at a frequency of 15.625 MHz and a corresponding received signal, according to an embodiment.

FIG. 3A is an xAM image of a GV well obtained using the single pulse excitation at 15.625 MHz center frequency shown in FIG. 1A.

FIG. 3B is an xAM image of the GV well obtained using xAM-based broadband chirp imaging with thirteen (13) cycles at 12-24 MHz.

FIG. 3C is an xAM image of the GV well obtained using xAM-based broadband chirp imaging with twenty (20) cycles at 12-24 MHz.

FIG. 3D is an xAM image of the GV well obtained using xAM-based broadband chirp imaging with twenty six (26) cycles at 12-24 MHz.

FIG. 4A is a graph depicting received signals resulting from the single pulse excitation in FIG. 1A and the thirteen (13) cycle coded chirp-based transmission with and without matched filtering, according to embodiments.

FIG. 4B is a graph depicting received signals resulting from the single pulse excitation in FIG. 1A and the twenty six (26) cycle coded chirp-based transmission with and without matched filtering, according to embodiments.

FIG. 5 is a schematic diagram of components of a nonlinear ultrasound imaging system, according to various implementations

FIG. 6 is a simplified block diagram of components of an xAM ultrasound imaging system, according to various implementations.

FIG. 7A is a cross-sectional drawing of a portion of an ultrasound transducer probe during transmission of a first ultrasound plane wave of the xAM pulse sequence from a left half-aperture of a narrow-strip acoustic linear transducer array, according to an implementation.

FIG. 7B is a cross-sectional drawing of the portion of the ultrasound transducer probe in FIG. 7A during transmission of a second ultrasound plane wave of the xAM pulse sequence from the right half-aperture, according to an implementation.

FIG. 7C is a cross-sectional drawing of the portion of the ultrasound transducer probe in FIG. 6A during simultaneous transmission of cross-propagating ultrasound plane waves of the xAM pulse sequence from both half-apertures, according to an implementation.

FIG. 8 is a cross-sectional drawing of another portion of the ultrasound transducer probe in FIG. 7A depicting voltage pulse and time delays applied to the transducer elements of the left subaperture to direct the transmission of the first ultrasound plane wave, according to an implementation.

FIG. 9 is a schematic diagram of components of a nonlinear ultrasound imaging system, according to certain embodiments.

FIG. 10 illustrates a flowchart depicting an example process for nonlinear ultrasound imaging in accordance with some embodiments.

FIG. 11 illustrates a flowchart depicting an example process of normalized cross-correlation matched filtering in accordance with some embodiments.

FIG. 12 is a graph of results obtained using a normalized cross-correlation matched filtering technique, according to an embodiment.

FIG. 13A is an amplitude modulated image obtained using the single pulse excitation at 15.625 MHz center frequency shown in FIG. 1A, according to an embodiment.

FIG. 13B is an amplitude modulated image obtained using a broadband chirp excitation thirteen (13) cycles at 12-24 MHz without matched filtering, according to an embodiment.

FIG. 13C is an amplitude modulated image obtained using a broadband chirp excitation thirteen (13) cycles at 12-24 MHz with standard matched filtering, according to an embodiment.

FIG. 13D is an amplitude modulated image obtained using a broadband chirp excitation thirteen (13) cycles at 12-24 MHz with high resolution matched filtering (HR MF), according to an embodiment.

FIG. 14A is a graph depicting results obtained by a broadband chirp excitation thirteen (13) cycles at 12-24 MHz (i) without matched filtering, (ii) with standard matched filtering, and (iii) with normalized cross-correlation matched filtering (high resolution matched filtering) at a first rayline shown in FIG. 13D, according to an embodiment.

FIG. 14B is a graph depicting results obtained by a broadband chirp excitation thirteen (13) cycles at 12-24 MHz (i) without matched filtering, (ii) with standard matched filtering, and (iii) with high resolution matched filtering at a second rayline shown in FIG. 13D, according to an embodiment.

FIG. 15 illustrates a flowchart depicting an example process for nonlinear ultrasound imaging with Bessel beam(s), in accordance with some embodiments.

FIG. 16A is graph showing the acoustic pressure of the transmission waveform of a parabolic beam and a Bessel beam in the time domain, according to an embodiment.

FIG. 16B is graph showing the acoustic pressure of the transmission waveform of a parabolic beam and a Bessel beam in the frequency domain, according to an embodiment.

FIG. 17A is graph showing the acoustic pressure of the received waveform of a parabolic beam and a Bessel beam in the time domain, according to an embodiment.

FIG. 17B is graph showing the acoustic pressure of the received waveform of a parabolic beam and a Bessel beam in the frequency domain, according to an embodiment.

FIG. 18A is graph showing the received signal overlayed on the transmission signal for a parabolic beam, according to an embodiment.

FIG. 18B is graph showing the received signal overlayed on the transmission signal for a Bessel beam, according to an embodiment.

FIG. 19 is graph depicting plots of the normalized amplitude at different depths for different images obtained using nonlinear ultrasound methods, according to embodiments.

FIG. 20A is an amplitude modulated image obtained by implementing a Bessel beam and standard matched filtering using a template based on the transmission signal, according to an embodiment.

FIG. 20B is an amplitude modulated image obtained by implementing a parabolic beam from a parabolic amplitude modulating pulse sequence where standard matched filtering is applied, according to an embodiment.

FIG. 20C is an amplitude modulated image obtained by implementing a Bessel beam and high-resolution matched filtering, according to an embodiment.

FIG. 20D is an amplitude modulated image obtained by implementing a parabolic beam from a parabolic amplitude modulating pulse sequence where high-resolution matched filtering is applied, according to an embodiment.

FIG. 21A is an amplitude modulated image obtained by implementing a Bessel beam and matched filtering using a template based on a harmonic signal with a different frequency range than the transmission signal (matched filtering with harmonic frequency filter), according to an embodiment.

FIG. 21B is an amplitude modulated image obtained by implementing a parabolic beam from a parabolic amplitude modulating pulse sequence where matched filtering with harmonic frequency filter, according to an embodiment.

FIG. 21C is an amplitude modulated image obtained by implementing a Bessel beam and high-resolution matched filtering is applied using a template based on a harmonic signal with a different frequency range than the transmission signal (high resolution matched filtering with harmonic frequency filter), according to an embodiment.

FIG. 21D is an amplitude modulated image obtained by implementing a parabolic beam from a parabolic amplitude modulating pulse sequence where high resolution matched filtering with harmonic frequency filter, according to an embodiment.

FIG. 22A is a pre-collapse BURST image obtained using a broadband chirp excitation of thirteen (13) cycles without matched filtering, according to an embodiment.

FIG. 22B is a pre-collapse BURST image obtained using a broadband chirp excitation of thirteen (13) cycles with standard matched filtering, according to an embodiment.

FIG. 22C is a pre-collapse BURST image obtained using a broadband chirp excitation of thirteen (13) cycles with high resolution matched filtering, according to an embodiment.

FIG. 23A is a first collapse BURST image obtained using a broadband chirp excitation of thirteen (13) cycles without matched filtering, according to an embodiment.

FIG. 23B is a first collapse BURST image obtained using a broadband chirp excitation of thirteen (13) cycles with standard matched filtering, according to an embodiment.

FIG. 23C is a first collapse BURST image obtained using a broadband chirp excitation of thirteen (13) cycles with high resolution matched filtering, according to an embodiment.

FIG. 24A is a second collapse BURST image obtained using a broadband chirp excitation of thirteen (13) cycles without matched filtering, according to an embodiment.

FIG. 24B is a second collapse BURST image obtained using a broadband chirp excitation of thirteen (13) cycles with standard matched filtering, according to an embodiment.

FIG. 24C is a second collapse BURST image obtained using a broadband chirp excitation of thirteen (13) cycles with high resolution matched filtering, according to an embodiment.

FIG. 25A is a BURST image, according to an embodiment.

FIG. 25B is a BURST image, according to an embodiment.

FIG. 26A is an example of BURST image of a GV well obtained using a Bessel beam, according to an embodiment.

FIG. 26B is an example of BURST image of a GV well obtained using a Bessel beam, according to an embodiment.

FIG. 26C is an example of BURST image of a GV well obtained using a Bessel beam, according to an embodiment.

FIG. 26D is an example of BURST image of a GV well obtained using a Bessel beam, according to an embodiment.

FIG. 27 is a schematic drawing illustrating weaker backscatter signals detected by transducer receive elements further away from scatterers primarily due to the receive element directionality, according to an embodiment.

FIG. 28A is an amplitude modulated image, according to an embodiment.

FIG. 28B is an amplitude modulated image obtained using targeted receive aperture procedure, according to an embodiment.

FIG. 28C is an amplitude modulated image obtained using targeted receive aperture procedure and denoising procedure, according to an embodiment.

FIG. 29 illustrates an example computing device, according to embodiments.

The figures and components therein may not be drawn to scale.

### DETAILED DESCRIPTION

Different aspects are described below with reference to the accompanying drawings. The features illustrated in the drawings may not be to scale. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments.

### I. Introduction to Nonlinear Ultrasound Imaging Techniques

The development of micro- and nanoscale acoustic biomolecules as contrast agents has broadened the capability of ultrasound imaging at the molecular and cellular level. Particularly, gas-filled protein nanostructures known as gas vesicles (GVs) provide the unique capability of ultrasound imaging cellular functions in vivo and in vitro. GVs are encapsulated by a protein shell that can endure large pressures of up to hundreds of kilopascals without collapsing. The shell's interior is markedly hydrophobic, preventing water ingress while permitting gas molecules to freely diffuse in and out of the interior. The low density and high compressibility of GVs enable effective sound wave scattering, generating substantial ultrasound backscatter. GVs can produce contrast across various medical ultrasound frequencies and can be genetically engineered for physical properties and surface functionality for use as targeted reporters. GVs exhibit pressure dependent nonlinear deformations under ultrasound, resulting in nonlinear acoustic signals. More particularly, certain GVs exhibit nonlinear scattering behavior in response to acoustic pressures above 300 kPa. This characteristic enables the use of amplitude-modulated (AM) ultrasound pulse sequences to effectively distinguish GVs from linear scatterers such as soft biological tissues.

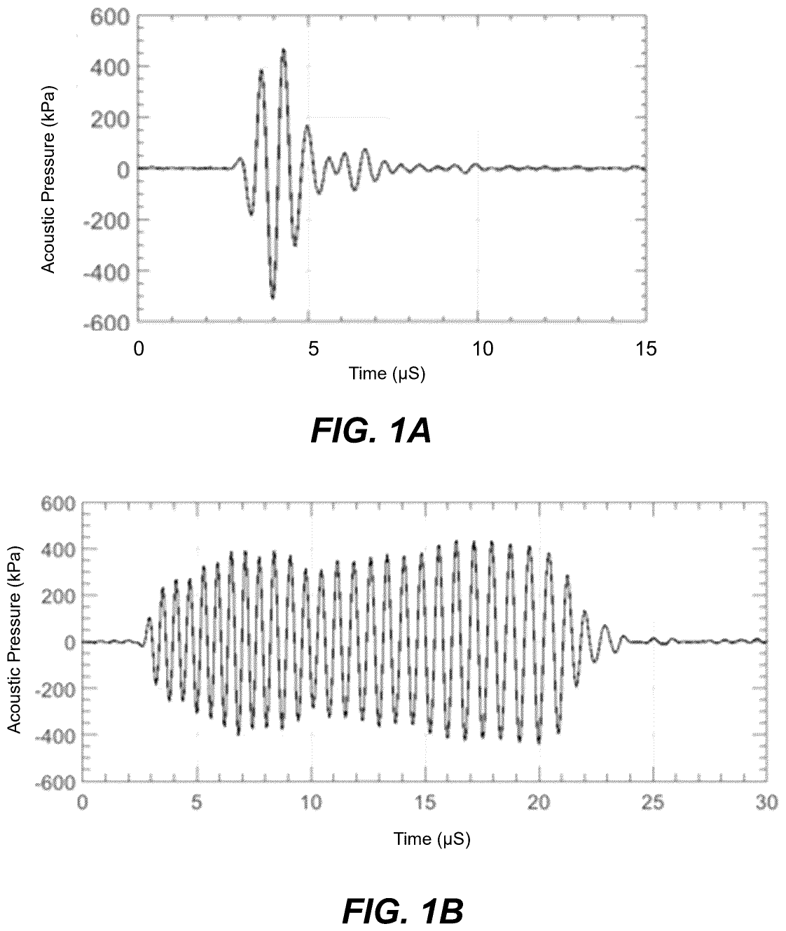

Amplitude-modulated imaging can be used to distinguish backscattering from acoustic biomolecules by employing a train of consecutive ultrasound pulses of different amplitudes. The acoustic biomolecules exhibit nonlinear scattering behavior in response, which enables amplitude-modulated imaging to distinguish the acoustic biomolecules from the surrounding tissues using the backscatter echo signals from the consecutive ultrasound pulses. Examples of modes of amplitude-modulated imaging include a cross-amplitude (xAM) imaging mode, a parabolic amplitude (pAM) imaging mode, and an ultrafast-amplitude (uAM) imaging mode, which are described in more detail in Section II. Typically, amplitude-modulated transmissions have a single cycle excitation. FIG. 1A illustrates a graph depicting an example of a cross-amplitude (xAM) ultrasound transmission measured using a hydrophone having a single cycle at 15.625 MHz center frequency.

Without being bound by theory, it is believed that the nonlinear response of acoustic biomolecules may build up over time and over multiple cycles and thus an elongated pulse with multiple cycles, particularly frequency cycles, may increase their nonlinear response. For example, it has been found that increasing the number of cycles in the ultrasound transmissions combined with frequency modulation may substantially increase the nonlinear response of GVs, thus advantageously improving their detection relative to surrounding linearly scattering tissues, without collapsing the air-filled proteins. An example of a signal that can be coded with frequency modulation having multiple cycles is a chirp signal. It has been found that GVs respond to the variation in frequency in chirp signals with a nonlinear response that also has a variation in frequency. The chirps could be an up or down sweep in frequency, changing from low to high or high to low frequencies across the transmission pulses, either in linear, logarithmic, exponential or other similar patterns. Similar to frequency-based encoding, once could use phase-based encoding using Barker codes or Golay codes to transmit extended pulse trains. Having coded transmissions also enable recovering axial spatial resolution using matched filtering algorithms. Further, these coded transmissions can be combined with amplitude modulation, pulse inversion, chirp reversal etc. and or similar other nonlinear imaging strategies or combinations there of. Further, these can be realized with cross-waves, plane wave, omni-directional spherical or cylindrical waves, divergent waves, focused beams etc. Although a chirp signal is used in some implementations described herein, it would be understood that any coded transmission may be used in accordance with other implementations.

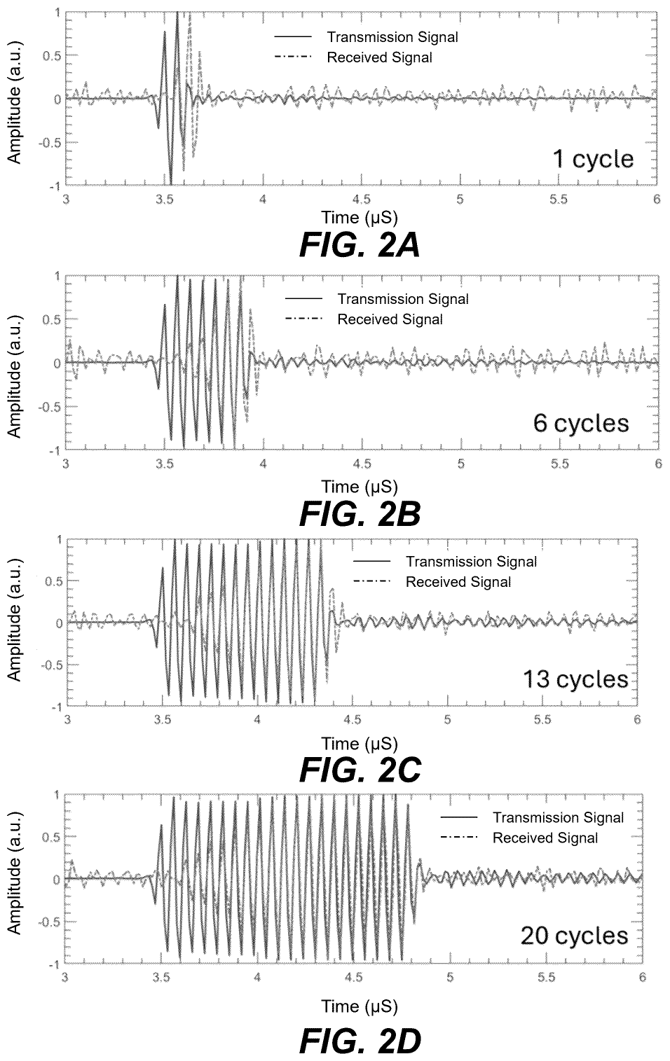

FIGS. 2A-2D are graphs depicting transmission signals and corresponding received signals of ultrasound transducers for amplitude modulation imaging of a tissue sample with GVs where the transmission signals have different numbers of cycles at a frequency of 15.625 MHZ, according to embodiments. FIG. 2A is a graph of a transmission signal having one (1) cycle at a frequency of 15.625 MHz and a corresponding received signal, according to an embodiment. FIG. 2B is a graph of a transmission signal having six (6) cycles at a frequency of 15.625 MHz and a corresponding received signal, according to an embodiment. FIG. 2C is a graph of a transmission signal having thirteen (13) cycles at a frequency of 15.625 MHz and a corresponding received signal, according to an embodiment. FIG. 2D is a graph of a transmission signal having twenty (20) cycles at a frequency of 15.625 MHz and a corresponding received signal, according to an embodiment. A comparison of the received signals and the transmission signals with multiple cycles in FIGS. 2B-2D shows a gradual increase in oscillation amplitude in the received signal after the first few cycles of the transmission signal. These examples show an oscillation offset in the GV nonlinear response which may indicate that GVs need time and a few cycles to build up amplitude in the nonlinear response, which is an attribute that can be harnessed for its co-localization using ultrasound. Similar response was also observed with chirp and Barker codes with multiple cycles.

Disclosed herein are techniques for nonlinear ultrasound imaging that involve transmitting a signal (transmission signal) to ultrasound transducers to generate coded ultrasound pulses to excite nonlinear response in acoustic biomolecules. Each coded ultrasound pulse is a pulse of ultrasound transmissions coded with multiple cycles of different frequencies and/or different phases. This multi-pulse coded-excitation approach is compatible for use with various amplitude modulation imaging modes including xAM, pAM, and uAM modes that can be used for nonlinear ultrasound imaging of GVs. Examples of signals that can be encoded with multiple frequency cycles (e.g., 6, 13, 20, 26, etc.) are chirps, Barker Codes, and Golay Codes. FIG. 1B illustrates a graph depicting an example of cross-amplitude (xAM) ultrasound transmission measured using a hydrophone of a twenty-six (26) cycle chirp with broadband frequency sweep at 12 to 24 Mhz, according to an embodiment. Examples of signals that can be encoded with multiple phase cycles are Barker codes, Chirps, and Golay Codes.

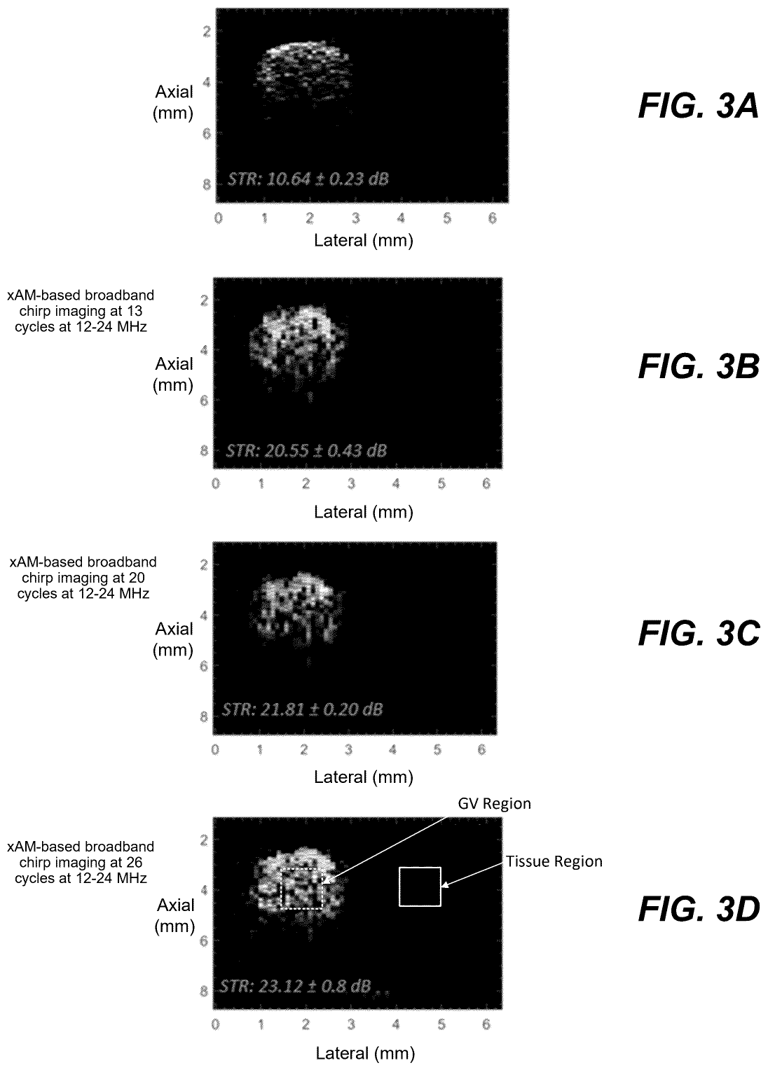

In certain embodiments, nonlinear ultrasound imaging techniques employ an amplitude modulation imaging procedure to image nonlinear scatterers such as acoustic biomolecules. During an example amplitude modulation imaging procedure, a transmission signal with multiple cycles is sent to transducers and particular transducers are silenced to send a train of consecutive ultrasound pulses with different amplitudes into the tissue being imaged. The acoustic biomolecules in the cells of the tissues are excited by the pulses. In some instances, the acoustic signatures from the acoustic biomolecules may be buried in noise of the received signal, particularly for acoustic biomolecules located deep within the tissues. To suppress noise, a matched filter procedure (also referred to herein as “matched filtering” or “match filtering”) may be employed in certain instances. The matched filter procedure typically uses the transmission signal as a template to generate a matched filter that is applied to the received signal, which suppresses noise improving the signal-to-noise ratio (SNR) of the nonlinear signal from the acoustic biomolecules. For example, the twenty-six (26) cycle chirp in FIG. 1B can be used as a template for matched filtering-based pulse compression used to generate the xAM image shown in FIG. 3D. A matching template can also be generated synthetically for a given frequency range, to extract a certain bandwidth, such as harmonics, sub-harmonics, ultraharmonics, etc. Before matching the template, the receive data may be filtered to better match the template bandwidth.

Without being bound by theory, it has been found that sending elongated pulses with varying frequency such as chirps may increase the harmonic content of biomolecules in the received signal. In one embodiment, when performing matched filtering, instead of using a template based on the transmission signal, a template is generated based a harmonic signal with a frequency range that is different than the frequency range of the transmission signal. For example, if a transmission signal has a broadband frequency range sweeping between 10 to 20 MHz, the template may be in a higher range between 20-40 MHz to capture the higher frequency signals (higher harmonics). This technique may advantageously avoid artifacts from the skin and other tissues that might generate backscatter signals in the fundamental frequency range. This approach may also help in improving the imaging resolution.

In some embodiments, nonlinear ultrasound imaging techniques may employ mismatched filtering where the filter is generated from a template based on a windowed transmission signal. The windowed transmission signal is generated by applying a filter window to the transmission signal. Some examples of types of filter windows that can be used include a Hamming window, a Hanning window, a Kaiser window, a rectangular window, a Flat Top window, a Tukey window, a uniform window, an exponential window, a Blackman window, a Bartlett-Hann window, a Bartlett window, a Blackman-Harris window, a Bohman window, a Chebyshev window, a Gaussian window, a Hann window, a Nuttall's Blackman-Harris window, a Parzen (de la Vallée-Poussin) window, a tapered cosine window, and a triangular window.

In some embodiments, nonlinear ultrasound imaging techniques may include a normalized cross-correlation matched filtering technique (also sometimes referred to herein as “HS MF”) to retain portions of the received signal with high correlation with the template while suppressing other portions, which may advantageously improve image resolution by suppressing broad mainlobes and sidelobes, especially in imaging sparse cell detection or tracking of metastasis during early stage of cancer. In these examples, a normalized correlation value is determined at every point of matching between the received signal and the template. If the normalized correlation value is lower than a certain threshold, the value at that point is set to zero or nearly zero, whereas the signal corresponding to higher normalized correlation value will be assigned its full correlation amplitude as determined based on the convolution operation.

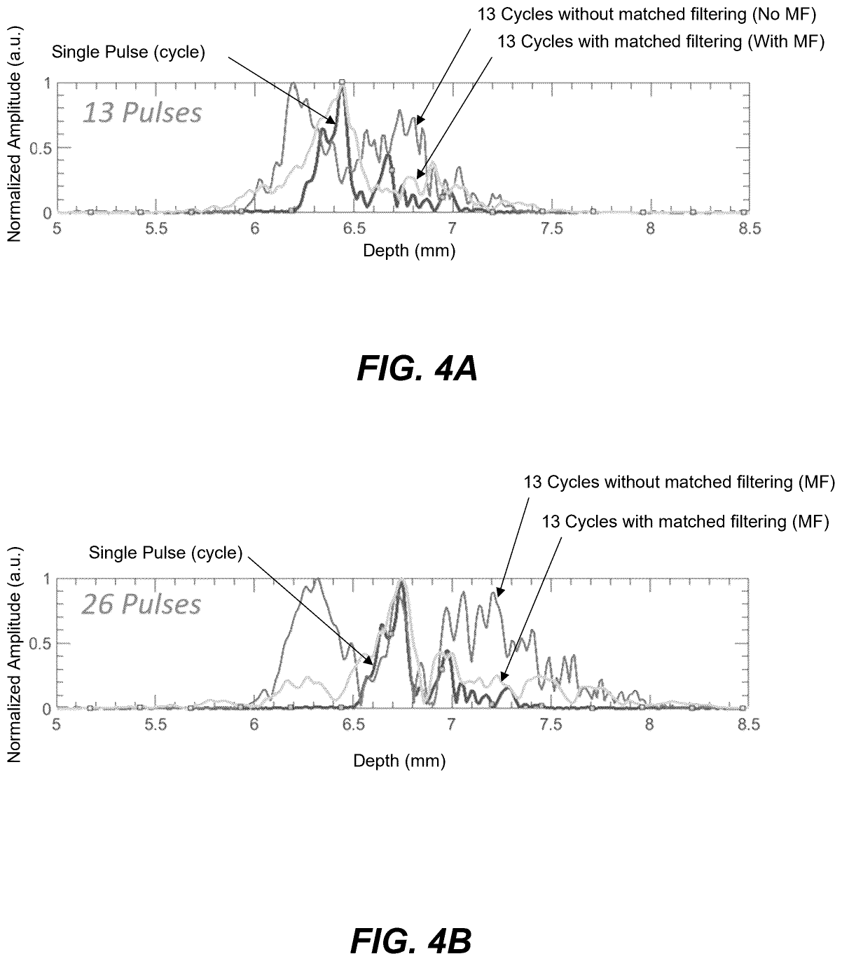

Examples of nonlinear imaging ultrasound techniques using a cross-amplitude modulation imaging mode with a matched filter procedure were used to image GV wells in a tissue mimicking phantom containing stripped Anabaena GVs target inclusions (OD: 3.2). In a series of imaging runs, these nonlinear imaging ultrasound techniques used single cycle and multi-cycle pulses implemented on a scanner with a linear transducer array such as the 128-channel scanner with L22-14vX linear transducer array probe made by Verasonics. Specifically, the single pulse transmissions were emitted at center frequency of 15.625 MHz, whereas the coded chirp excitation was transmitted using pulse lengths of either 13, 20 and 26 cycles, sweeping across the full bandwidth of the linear transducer array (12-24 MHz). The received signal with the raylines associated with the multi-pulse transmissions were pulse compressed using a matched filter based on a template taken from the transmission signal in FIG. 1B, prior to applying time delays to the acoustic waves of the pulses in the xAM pulse sequence and prior to sum beamforming. Alternatively, time delays may be applied and then the matched filtering. Specifically, the pulse compression used standard matched filtering that involved estimating correlation between the received signal and a template of the transmission signal. FIGS. 3A-3D are the resulting xAM images of a GV well in a tissue mimicking phantom acquired using these nonlinear imaging ultrasound techniques in accordance with embodiments. FIG. 3A is an xAM image of a GV well obtained using the single pulse excitation at 15.625 MHz center frequency shown in FIG. 1A. FIG. 3B is an xAM image of the GV well obtained using xAM-based broadband chirp imaging with thirteen (13) cycles at 12-24 MHz. FIG. 3C is an xAM image of the GV well obtained using xAM-based broadband chirp imaging with twenty (20) cycles at 12-24 MHz. FIG. 3D is an xAM image of the GV well obtained using xAM-based broadband chirp imaging with twenty six (26) cycles at 12-24 MHz. A signal-to-noise-ratio was calculated for the xAM image in FIG. 3A and for the xAM image in FIG. 3D based on the GV and tissue regions indicated in FIG. 3D. The chirp based broadband multi-pulse image with twenty six (26) cycles shown in FIG. 3D had a signal to tissue ratio improvement over the single pulse xAM image in FIG. 3A of greater than 12 dB. FIG. 4A is a graph depicting (i) a received signal resulting from the single pulse excitation at 15.625 MHz center frequency shown in FIG. 1A, (ii) a received signal resulting from the thirteen (13) cycle coded chirp-based transmission after pulse compression with matched filtering (MF) is applied, and (iii) a received signal resulting from the thirteen (13) cycle coded chirp-based transmission without matched filtering. FIG. 4B is a graph depicting (i) a received signal resulting from the single pulse excitation at 15.625 MHz center frequency shown in FIG. 1A, (ii) a received signal resulting from the twenty six (26) cycle coded chirp-based transmission after pulse compression with matched filtering (MF) is applied, and (iii) a received signal resulting from the twenty six (26) cycle coded chirp-based transmission without matched filtering. By comparing the received signal with and without matched filtering for both the thirteen (13) and twenty six (26) cycle coded chirp-based transmission, it can be seen that matched filtering restores the loss in axial resolution associated with multi-pulse transmission to that comparable with the single pulse rayline. The results of the imaging runs generally demonstrate that that chirp based broadband multi-pulse imaging (1) improved signal to tissue ratio by over 12 dB compared to conventional single pulse xAM imaging of GVs, (2) pulse compression using matched filtering was successful in recovering axial resolution, and (3) multi-pulse coded transmissions were compatible with AM modes of nonlinear ultrasound imaging of GVs.

Similarly, mismatched filtering was achieved by using a windowed transmission signal as a template, which helped reduce side-lobes associated with correlation-based matched filtering approach.

In various embodiments, nonlinear ultrasound imaging techniques use pulses that generate an acoustic beam scanned across a field-of-view. For example, where a pAM imaging mode is employed, a parabolic beam may be created along an axis. In certain embodiments, a nonlinear ultrasound imaging technique forms a non-diffracting Bessel beam of ultrasound energy (also referred to herein as “acoustic Bessel beam”) to extend the depth of the focus, which can advantageously improve the depth of field and quality of the images of the acoustic biomolecules. An acoustic Bessel beam generally refers to a non-diffracting beam of ultrasonic energy that exhibits little to no diffraction with propagation. An acoustic Bessel beam has a narrow width for an extended focal length. Some examples of focal lengths for acoustic Bessel beams may be in a range of 1 mm to 5 mm for the L22-14 ultrasound probe made by Verasonics.

During an ultrasound imaging procedure, certain transducers such as those at the edges of transducers arrays, may detect weaker backscatter signals. In some embodiments, nonlinear ultrasound imaging techniques may include a targeted receiver aperture (TRA) procedure that suppresses backscatter signals from transducers having low correlation.

Certain nonlinear ultrasound imaging techniques apply frequency-modulated multi-pulse broadband transmissions to collapse-based ultrasound reconstructed with signal templates (BURST) imaging of GVs, to exploit the enhanced cavitation effect associated with extend transmission pulses, while preserving imaging resolution. In BURST imaging, a series of ultrasound images is acquired during which the transmit acoustic pressure undergoes a step-change from a value below the GV collapse threshold to above it. This step-change generates a transient collapse-based signal increase in voxels containing GVs, while the signal from non-GV linear scatterers steps up and persists with the higher applied pressure. The images acquired during this pulse train combine to form a time-series vector for each voxel in the field of view. In BURST signal processing, these vectors are decomposed into weighted sums of template vectors representing the expected signal patterns of GVs, linear scatterers and background noise or offset, allowing for the generation of images specific to each source of signal. BURST imaging may improve the detection sensitivity of GV-expressing cells by isolating the strong signal impulse generated by GVs at the moment of their collapse, while subtracting background linear contrast. Without being bound by theory, BURST imaging may benefit from longer pulses having multiple cycles due to cavitation of the gas bubble formed due to coalescing, post collapse of the GVs. However, even though using longer pulses may help with improved detection it may spoil the axial resolution. However, chirp matched filtering can be performed to recover resolution. Also, certain implementations may further combine with Bessel beam and/or TRA, to further improve detection.

Although certain examples are described herein with reference to gas vesicles, it would be understood that these examples may also apply to other acoustic biomolecules in accordance with other implementations. An acoustic biomolecule generally refers to a protein or other gas bubbles that can scatter sound. Some examples of acoustic biomolecules include gas vesicles (GVs), microbubbles, and nanobubbles. Gas vesicles have gas-filled compartments with typical widths in a range from 45 nm to 250 nm and typical lengths in a range of 100 nm to 600 nm that exclude water and are permeable to gas (e.g., air). The gas-filled compartments are enclosed by a protein shell such as, e.g., a 2 nm-thick protein shell. Gas vesicles may exhibit non-linear scattering behavior in response to acoustic pressures above a certain threshold (e.g. 300 kPa) which enables the use of ultrasound pulses to effectively distinguish the nonlinear scattering gas vesicles from linear scatterers in surrounding soft biological tissues.

### II. Examples of Nonlinear Ultrasound Imaging Systems

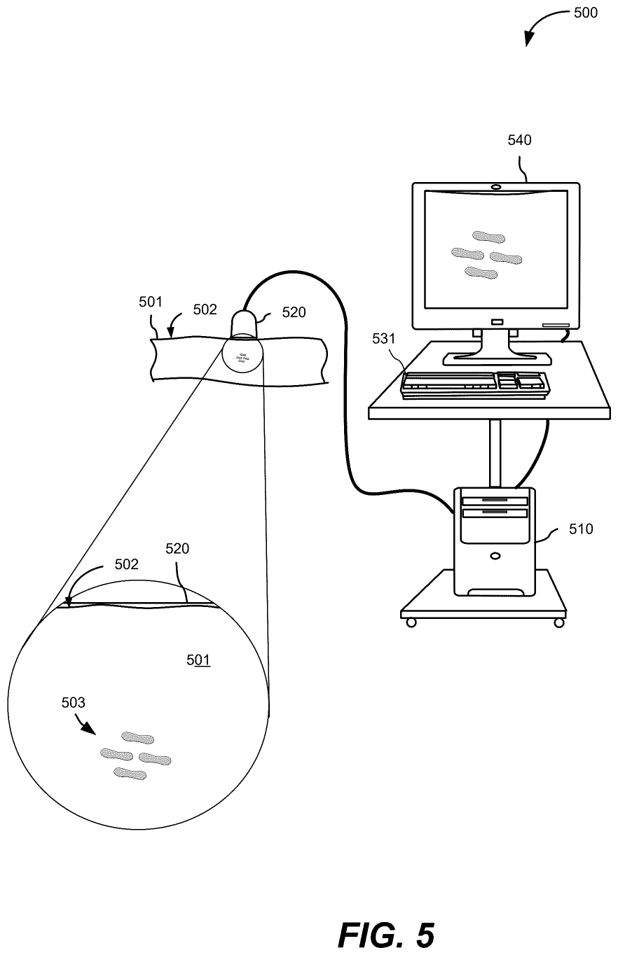

Nonlinear ultrasound imaging modes can be generally categorized as non-destructive or destructive. An amplitude modulation imaging mode is an example of non-destructive imaging. In an amplitude modulation (AM) imaging mode, consecutive transmissions (train of pulses) of different amplitudes are generated by silencing different sets of transducers in an arrangement of transducer elements (e.g., one or more transducer arrays) and detecting backscatter echo signals. For example, an AM sequence may include three consecutive sine-bursts of relative amplitudes 1, ½, and ½. The half-amplitude transmissions may be achieved by silencing the odd or even elements of an arrangement of transducer elements, while the full-amplitude transmission uses all the transducer elements. Some examples of different types of amplitude-modulated imaging modes include a cross-amplitude (xAM) imaging mode, a parabolic amplitude (pAM) imaging mode, and an ultrafast-amplitude (uAM) imaging mode. An example of xAM pulse sequence is described with reference to FIG. 5 below. An example of a pAM pulse sequence is full amplitude, followed by two half amplitude pulses. pAM is accomplished by applying parabolic delays across the probe sub-apertures to generate specific raylines. uAM is using ultrafast planewaves that could be in multi-planewave configuration supported by Hadamard encoding or without the multi-plane wave configuration. Some examples of nonlinear ultrasound imaging modes that are destructive include BURST imaging. With BURST imaging, the pulse train transmits an acoustic pressure above the GV collapse threshold.

FIG. 5 is a schematic diagram of components of a nonlinear ultrasound imaging system 500, according to various implementations. The nonlinear ultrasound imaging system 500 includes a computing device 510 for performing certain operations of a nonlinear ultrasound imaging method, an ultrasound transducer probe 520 having an arrangement of transducers (e.g., one or more linear or curved arrays) 521 for transmitting one or more ultrasound pulse sequences and detecting backscatter echoes, one or more input devices including a keyboard 531, and a display 540. The computing device 510 is in electrical communication with the ultrasound transducer probe 520, the one or more input devices, and the display 540.

The computing device 510 includes one or more processors and an internal memory device (also sometimes referred to herein as a non-transitory computer readable medium (CRM)) in electronic communication with the one or more processors. The one or more processors of the computing device 510 and, additionally or alternatively, other processor(s) of the execute instructions stored on the internal memory device to perform operations of nonlinear ultrasound imaging methods and other functions of the nonlinear ultrasound imaging system 500. The described electrical communications between components of the nonlinear ultrasound imaging system 500 may provide power and/or communicate data. In addition, the communication between system components may be wired or wireless.

For illustration purposes, the nonlinear ultrasound imaging system 500 is shown with the ultrasound transducer probe 520 touching or coupled via a coupling material (e.g., acoustic gel) to a surface 502 of a specimen 501 with nonlinear scatterers 503 being imaged during a nonlinear ultrasound imaging method. As used herein, a “nonlinear scatterer” generally refers to a feature that scatters a propagating ultrasound wave such that the detected backscatter echo signal is not a linear transformation, or function of, the ultrasound wave transmitted from the ultrasound transducer. Some examples of nonlinear scatterers are buckled GVs and resonant microbubbles. Another example of nonlinear scatterers are cracks in material (e.g., in a bone) or any sub-wavelength gas inclusion.

In various implementations, a nonlinear ultrasound imaging system includes an ultrasound transducer probe (e.g., ultrasound transducer probe 520 in FIG. 5) having a housing and an arrangement of transducer elements enclosed within the housing. Generally, the ultrasound transducer probe also includes attachments for coupling the transducer elements to the housing and connectors for electrically communicating with other system components. A commercially-available example of an ultrasound probe is the L11-5V probe and the L22-14v probe by Verasonics® located in Redmond, WA, USA.

As used herein, an “arrangement of transducers elements” generally refers to any arrangement (linear, curved one-dimensional or two-dimensional, one or more arrays, etc.) of ultrasound transducer elements that can transmit acoustic waves in the ultrasound range (ultrasound waves) and convert ultrasound waves detected into backscatter echo signals. Typically, each ultrasound transducer element can transmit an ultrasound wave and can generate a backscatter echo signal. In one aspect, the ultrasound transducer elements are piezoelectric elements. In another aspect, the ultrasound transducer elements are complementary metal oxide semiconductor (CMOS) ultrasound transducer elements. Any reflective surfaces and scatterers that lie along the propagation path of an ultrasound wave can cause reflection and scatter.

In many implementations, an arrangement of ultrasound transducers of a nonlinear ultrasound imaging system is an analog transducer, which generates electrical signals in response to receiving ultrasound waves and activates transducer elements by applying a voltage transmission waveform (also referred to herein as voltage transmission pulses) to each transducer element. In these cases, the nonlinear ultrasound imaging system includes an analog/digital converter that converts the electrical signals into digital data and a digital/analog converter to convert control signals to voltages applied to each of the transducer elements in a time delayed sequence. These converters may be part of the computing device, part of the transducer probe, or may be separate components. In other implementations, the transducer elements are digital transducers and the analog/digital converter and digital/analog converter can be omitted.

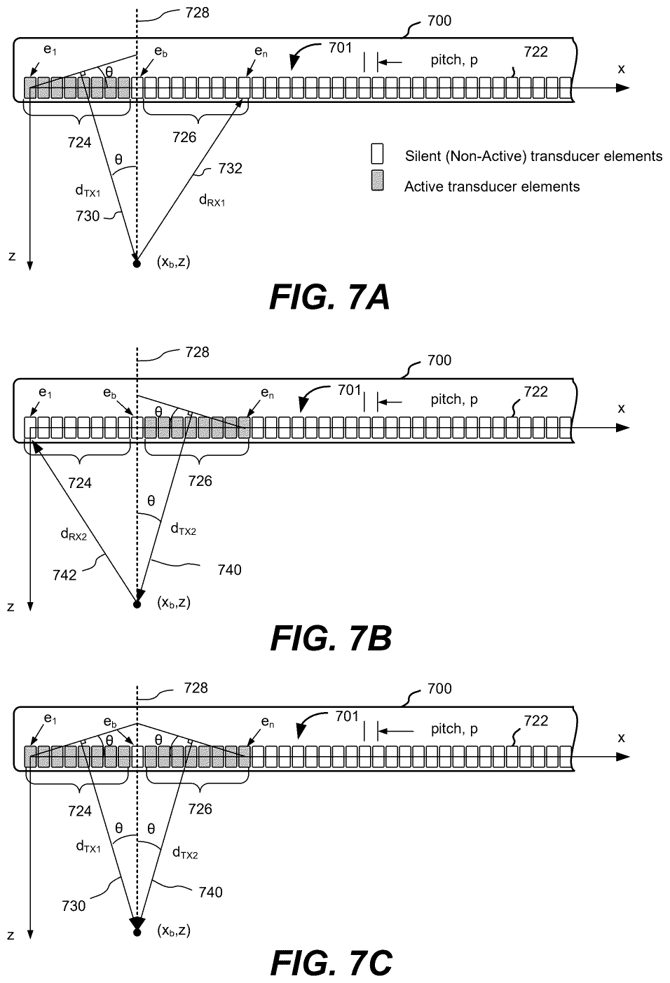

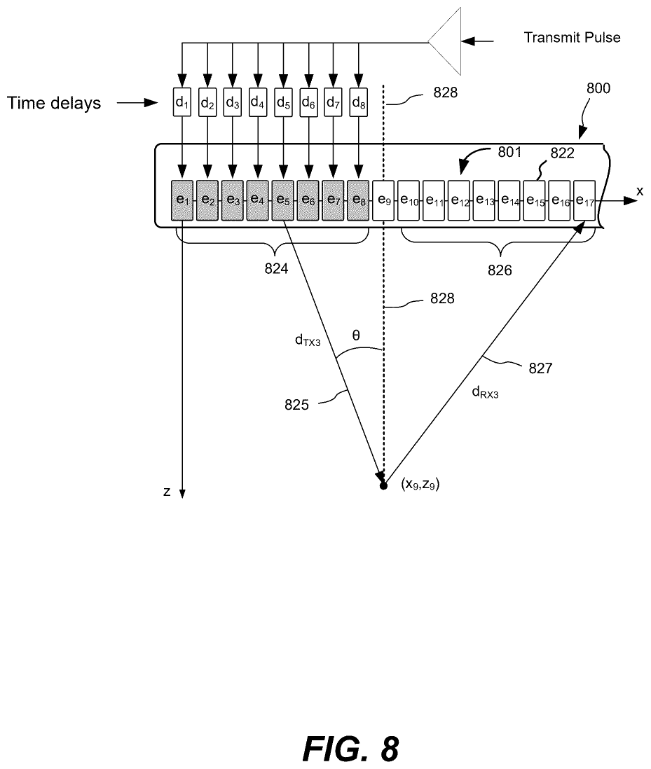

The arrangement of transducer elements is configured or configurable to activate and/or silence certain apertures (sets of transducer elements) to generate amplitude modulation (AM) pulse sequences to form an acoustic beam sweeping across a field-of-view. In some implementations, the arrangement of transducer elements is a one-dimensional array such as the linear array illustrated in FIGS. 7A-7C and FIG. 8 or a curved one-dimensional array. Backscatter echo signals detected by the one-dimensional array can be used to generate a two-dimensional image. Multiple two-dimensional images at different planes can be stacked to form a three-dimensional image. In other implementations, the transducer array is a two-dimensional array of transducer elements. Backscatter echo data detected by a two-dimensional array can be used to generate a three-dimensional (volumetric) image.

In some implementations, the nonlinear ultrasound imaging system also includes one or more input devices that are in communication with the computing device. The operator can use the input devices to adjust imaging parameter(s) used in the nonlinear ultrasound imaging method such as one or more of: 1) the number of cycles in the transmission signal, 2) the frequency range of the transmission signal, 3) the amplitudes of the amplitude modulation pulse sequence, 4) the correlation threshold value, 5), the type of nonscattering feature being imaged, 6) the depth of field.

During an example operation, the computing device sends control signals, converted into a voltage pulse with transmit delays communicated to the ultrasound transducer probe to activate different sets of transducer elements to sweep an acoustic beam formed by an amplitude modulated pulse sequence to different locations across a field-of-view. An example of an amplitude modulated pulse sequence is an xAM pulse sequence. An xAM pulse sequence includes transmission of a first ultrasound plane wave (first pulse), transmission of a second ultrasound plane wave (second pulse), and simultaneous transmission of both the first and second noncollinear ultrasound plane waves (third pulse). These pulses can be transmitted in any order. The second ultrasound plane wave is in a direction axisymmetric to the first ultrasound plane wave about a bisector. The first and second ultrasound plane waves are at a cross-propagation angle from the bisector. The simultaneous transmission of both the first and second ultrasound plane waves (third pulse) generates a peak acoustic pressure in the specimen where the first and second ultrasound plane waves intersect at the virtual bisector. An example of a voltage pulse with transmit delays applied to transducer elements of the arrangement of transducer elements to generate an xAM pulse sequence is described with reference to FIGS. 7A-7C and FIG. 8. The amplitude of the first and second ultrasound plane waves is defined so that when transmitted individually the peak acoustic pressure is below a threshold, e.g., a buckling threshold, a collapse threshold, or a cavitation threshold, and when transmitted simultaneously the peak acoustic pressure at the bisector is above the threshold. The ultrasound transducer converts the ultrasound waves from backscatter echoes detected at its face into backscatter echo signals. The computing device digitally sums the echo signals from the two plane-wave transmissions and then digitally subtracts them from the echo signals of the X-wave transmissions. In this way, the nonzero differential nonlinear scattering signal is solely retrieved, while the echo signal of surrounding linear scatterers cancel. The computing device combines the image data for all the locations across the field-of-view to generate an ultrasound image of the nonlinear scatterers.

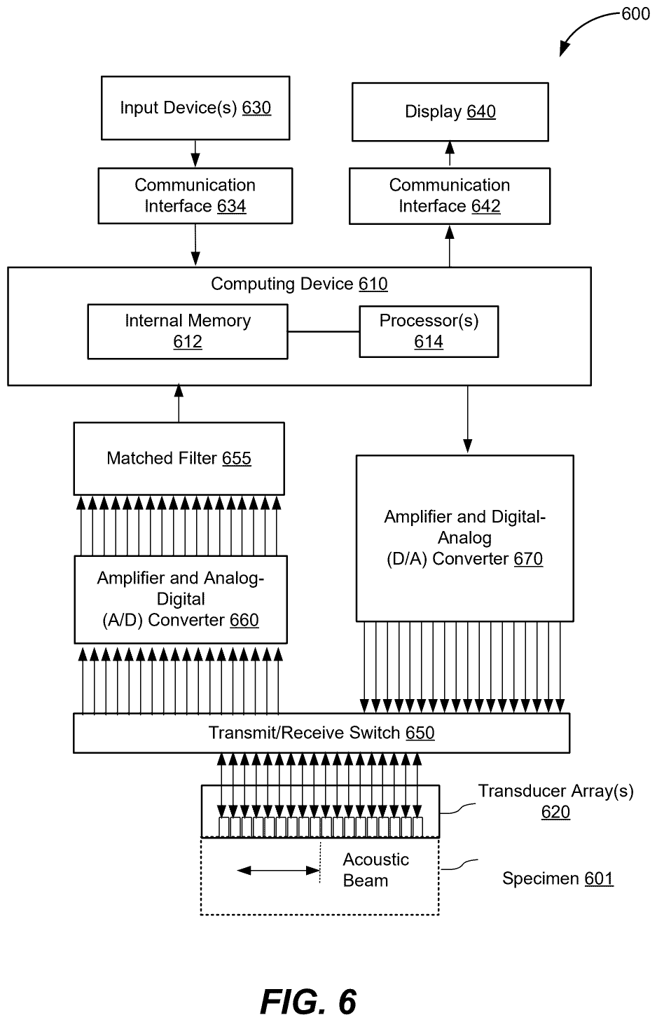

FIG. 6 illustrates a simplified block diagram of components of a nonlinear ultrasound imaging system 600, according to certain implementations. For the sake of brevity, the prior discussion of such similar or analogous elements with regard to FIG. 5 may be assumed to be equally applicable, unless indicated otherwise in the following discussion, to the similar or analogous counterparts of those elements in FIG. 6 that share the same last two digits in their respective callouts as in FIG. 5. The nonlinear ultrasound imaging system 600 includes a computing device 610 with one or more processors 614 and an internal memory device 612 in electrical communication with the one or more processors 614. The nonlinear ultrasound imaging system 600 also includes an arrangement of transducer elements 620 for transmitting one or more amplitude modulated ultrasound pulse sequences and detecting backscatter echoes. The nonlinear ultrasound imaging system 600 also includes a transmit/receive switch 650, a matched filter 655, an amplifier and analog-digital converter 660, and an amplifier and digital-analog converter 670. In another implementation, one or more of the amplifiers and converters may be omitted.

The transmit/receive switch 650 is in electronic communication with the arrangement of transducer elements 620, an amplifier and analog-digital converter 660, and the amplifier and digital/analog converter 670. The matched filter 655 is electronic communication with the analog/digital converter 660. In one implementation, the amplifier and analog/digital converter 660 includes multiple amplifiers. For example, the system may include a total gain amplifier for amplifying the signal from the arrangement of transducer elements 620, an amplifier for amplifying the signal from the first set of transducer elements and an amplifier for amplifying the signal from the second set of transducer elements.

The nonlinear ultrasound imaging system 600 also includes one or more input devices 630 and a communication interface 634 in communication with the input device(s) 630. The nonlinear ultrasound imaging system 600 also includes a communication interface 642 and a display 640 in communication with the communication interface 642. The computing device 610 is also in communication with the communication interface 634 and the communication interface 642. For illustration purposes, the nonlinear ultrasound imaging system 600 is depicted as sweeping (denoted by double arrow) an acoustic beam formed by an amplitude modulated pulse sequence across a field-of-view of a specimen 601 during an amplitude modulated imaging operation. The described electrical communications between components of the nonlinear ultrasound imaging system 600 may be able to provide power and/or communicate data.

In certain implementations, a nonlinear ultrasound imaging system includes a transmit/receive switch that controls the delivery of the voltage pulse with time delays to the transducer elements and the receiving of electrical signals with backscatter echo data received from each transducer elements. The transmit/receive switch can isolate the transmitting circuitry from the receiving circuitry. A commercially-available transmit/receive switch is one of the Ultrasound T/R Switch ICs by Microchip Technology of Mansfield, Texas. For example, the nonlinear ultrasound imaging system 600 in FIG. 6 includes the transmit/receive switch 650 that can switch between: (i) receiving electrical signal(s) with backscatter echo data from the arrangement of transducer elements 620, and (ii) sending a voltage pulse with time delays to the transducer elements. In implementations that do not include the switch, the voltage signals used to excite the transducer elements cause a ringdown signal to be appended to the start of the received signal. In this case, the ringdown signal is removed during beamforming.

The computing device 610 is configured or configurable by an operator, e.g., based on input from the input device(s) 630, to display input data or raw or processed image data over the communication interface 642 for display on the display 640. The computing device 610 is also configured or configurable by an operator, e.g., based on input from the input device(s) 630, to send control signals to the amplifier and digital-analog converter 670. The amplifier and digital/analog converter 670 can convert the control signals to a voltage pulse with time delays transmitted via the transmit/receive switch 650 to the transducer elements of the arrangement of transducer elements 620 to activate the transducer elements to generate the pulse and detect backscatter echoes. An example of a voltage pulse with time delays used to generate an amplitude modulated ultrasound pulse sequence is described with respect to FIGS. 7A-7C and 8. The ultrasound waves detected by the arrangement of transducer elements 620 generate electrical backscatter echo signals, which are communicated to the amplifier and analog/digital converter 660. The amplifier and analog/digital converter 660 amplifies and converts the electrical backscatter echo signals to digital backscatter echo data communicated to the computing device 610. The computing device 610 is also configured or configurable to digitally sum the backscatter echo data from the two plane-wave transmissions and digitally subtract the sum from the backscatter echo data of the ultrasound transmissions to determine backscatter echo data from the nonlinear scatterers and then combine for all the amplitude modulated pulse sequences swept over the field-of-view to generate an ultrasound image of the nonlinear scatterers.

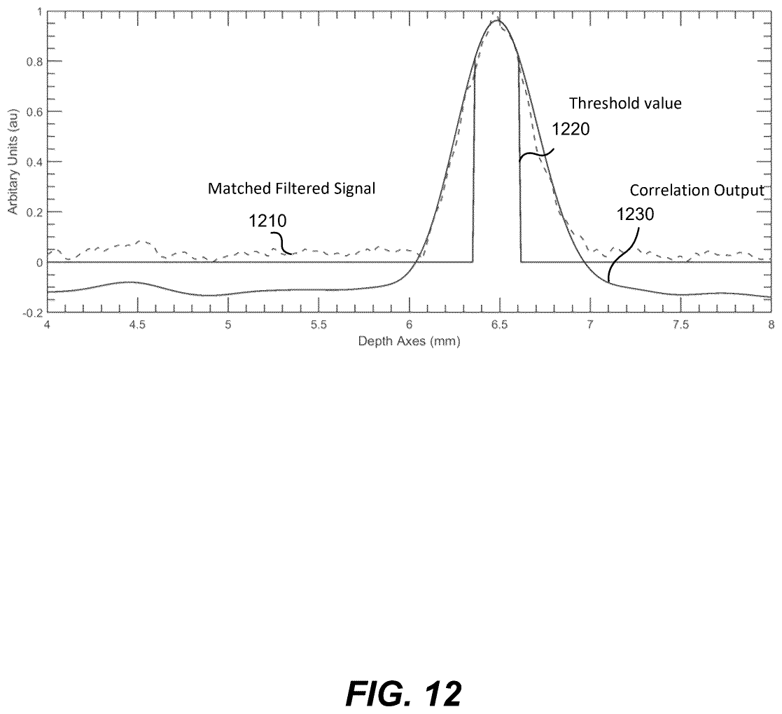

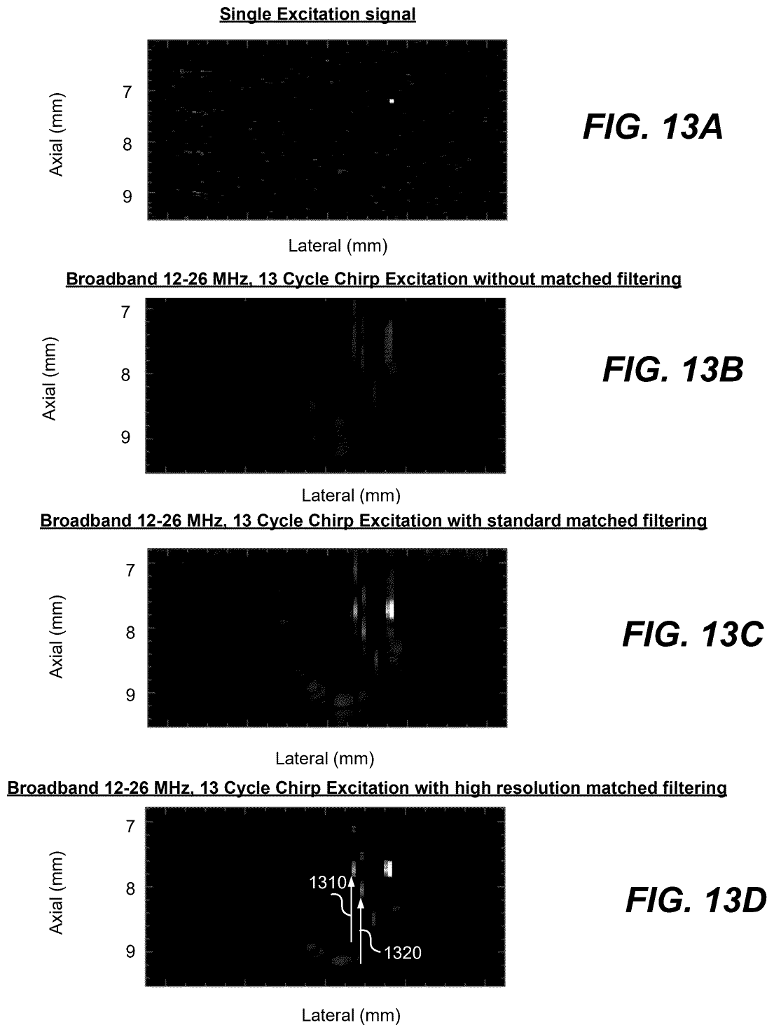

In various implementations described herein, the computing device of the nonlinear ultrasound imaging system includes one or more processor(s). These processor(s) may be, for example, one or more of a general purpose processor (CPU), an application-specific integrated circuit, an programmable logic device (PLD) such as a field-programmable gate array (FPGA), or a System-on-Chip (SoC) that includes one or more of a CPU, application-specific integrated circuit, PLD as well as a memory and various interfaces. In FIG. 6, the one or more processor(s) 614 of the computing device 610 and, additionally or alternatively, other processor(s) of the nonlinear ultrasound imaging system 600 execute instructions stored on a computer readable medium (e.g., the internal memory 612 or external memory) to perform operations of the nonlinear ultrasound imaging system 600. For example, the one or more processor(s) 614 of the computing device 610 may communicate control signals to the digital/analog converter 670 which are converted to a voltage pulse with time delays (also sometimes referred to herein as “voltage transmission pulses”) to activate the transducer elements of the arrangement of transducer elements 620 to transmit amplitude modulated pulse sequences during an imaging operation. The one or more processor(s) 614 of the computing device 610 may also perform operations of a nonlinear ultrasound imaging method to process the backscatter echo data to generate ultrasound images of nonlinear scatterers. Examples of nonlinear ultrasound imaging methods are described in detail with respect to FIGS. 12 and 13.

In various embodiments described herein, ultrasound images of nonlinear scatterers are generated by nonlinear ultrasound imaging techniques. An example of nonlinear scatterers may include engineered cell expressing gas vesicles.

In various implementations described herein, the computing device includes an internal memory device. The internal memory device may include a non-volatile memory array for storing processor-executable code (or “instructions”) that is retrieved by the processor(s) to perform various functions or operations described herein for carrying out various logic or other operations on the backscatter echo signals or image data. The internal memory device also can store raw backscatter echo data and/or processed image data. In some implementations, the internal memory device or a separate memory device can additionally or alternatively include a volatile memory array for temporarily storing code to be executed as well as image data to be processed, stored, or displayed. In some implementations, the computing device itself can include volatile and in some instances also non-volatile memory.

The nonlinear ultrasound imaging system 600 further includes a communication interface 642 and a display 640 in communication with the communication interface 642. The computing device 610 is configured or configurable to communicate data over the communication interface 642 for display on the display 640 including, e.g., input data for the pulses of the amplitude modulated pulse sequences, raw backscatter echo data, and processed image data. The nonlinear ultrasound imaging system 600 also includes a communication interface 634 in communication with the input device(s) 630 for receiving input from an operator of the nonlinear ultrasound imaging system 600.

In some implementations, the nonlinear ultrasound imaging system further includes one or more additional interfaces such as, for example, various Universal Serial Bus (USB) interfaces or other communication interfaces. Such additional interfaces can be used, for example, to connect various peripherals and input/output (I/O) devices such as a wired keyboard or mouse or to connect a dongle for use in wirelessly connecting various wireless-enabled peripherals. Such additional interfaces also can include serial interfaces such as, for example, an interface to connect to a ribbon cable. It should also be appreciated that the various system components can be electrically coupled to communicate with the computing device over one or more of a variety of suitable interfaces and cables such as, for example, USB interfaces and cables, ribbon cables, Ethernet cables, among other suitable interfaces and cables.

The data signals output by one or more transducer array(s) may in some implementations be mutliplexed, serialized or otherwise combined by a multiplexer, serializer or other electrical component of the nonlinear ultrasound imaging system before being communicated to the computing device. In certain implementations, the computing device can further include a demultiplexer, deserializer or other device or component for separating the backscatter echo data, e.g., separating backscatter echo data for amplitude modulated sequences for one propagation angle from backscatter echo data for amplitude modulated sequences from another propagation angle in a coherent compounding implementation so that the image frames for each propagation angle can be processed in parallel by the computing device.

The input device(s) 630 are in electrical communication with the computing device 610 through the communication interface 634 to be able to send a signal with imaging parameters to the computing device 610 based on input received at the input device(s) 630. The input device(s) 630 may include a tuner, for example. The tuner may be a separate component that includes various control mechanisms such as dials, switches, knobs, buttons, sliding bars, etc. In another case, the tuner may be an electronic tuner with graphical user interfaces, e.g., on a touchscreen of the display 640.

Although many of the components of nonlinear ultrasound imaging systems illustrated herein are shown in electronic communication with each other via wiring, it would be understood that the electronic communication between components described herein can be in wired or wireless form.

FIGS. 7A, 7B, and 7C each include a cross-sectional drawing of a portion of an ultrasound transducer probe 700 with a narrow-strip acoustic linear transducer array 701, according to an embodiment. The transducer array 701 includes one hundred twenty eight (128) transducer elements 722. A commercially-available narrow-strip acoustic linear transducer array is in the L11-5V probe and the L22-14v probe by Verasonics® located in Redmond, WA, USA. FIG. 8 is cross-sectional drawing depicting another portion of the ultrasound transducer probe 700. The narrow-strip acoustic linear transducer array 701 has a uniform pitch, p, between transducer elements 722. The linear transducer array 701 includes an x-axis through the center of the transducer elements, a z-axis originating from the first element, e₁, of the linear transducer array 701, and a y-axis (not shown) perpendicular to the x-axis and the z-axis.

In FIGS. 7A, 7B, and 7C respectively, the linear transducer array 701 is depicted during transmission of three pulses of an exemplary xAM pulse sequence. The linear transducer array 701 includes an aperture of N transducer elements that are active during the xAM pulse sequence. The aperture includes a first element, e₁, and an n^{th} element, e_{N}, which is an arbitrary element in the linear transducer array 701. The aperture includes a left subaperture 724 with a first set of transducer elements, e₁-e_{b-1}, and a right subaperture 726 with a second set of transducer elements, e_{b+1}-e_{N}. The linear transducer array 701 includes a virtual bisector 728 between the right subaperture 726 and the left subaperture 724. The transducer element e_{b}, lying along the virtual bisector 728 between the two subapertures 724, 726 is silent (inactive) during the xAM pulse sequence. In the illustrated example, the cross-propagation angle, θ, is the angle between the plane waves and the x-axis and also between the plane waves and the virtual bisector 728.

The exemplary xAM pulse sequence involves: (i) activating the first set of transducer elements of the left subaperture 724; (ii) activating the second set of transducer elements of the right subaperture 726; and (iii) simultaneously activating the first and second sets of transducer elements of the left and right sub-apertures 724, 726. The pulses of this sequence can occur in any order. The nonlinear ultrasound imaging method sequentially implements different windows of active transducer elements 722 in the acoustic linear transducer array 701 to sweep an acoustic beam formed by the xAM pulse sequences across the field-of-view. For example, one aperture of active transducer elements could include a first set of transducer elements, e₁-e₈, and a second set of transducer elements, e₁₀-e₁₇, another aperture of active transducer elements could include a third set of transducer elements, e₂-e₉, and a fourth set of transducer elements, e₁₁-e₁₈, and yet another aperture of active transducer elements could include a fifth set of transducer elements, e₃-e₁₀, and a sixth set of transducer elements, e₁₂-e₁₉, and so forth.

FIG. 7A depicts the active transducer elements of the left sub-aperture 724 of the linear transducer array 701 during operation (i) that transmits a tilted plane wave in a direction that is at cross-propagation angle, θ, from the x-axis and the virtual bisector 728. The illustrated example shows a distance d_{TX1} 730 from the planer wavefront to a point (x_{b}, z_{b}) along the virtual bisector 728 and a return distance d_{Rx1} 732 to the array 701. FIG. 7B depicts the active transducer elements of the right sub-aperture 726 of the linear transducer array 701 during operation (ii) that transmits a tilted plane wave in a direction that is at cross-propagation angle, θ, from the x-axis and the virtual bisector 728. The distance from the planer wavefront to a point (x_{b}, z_{b}) along the virtual bisector 728 is d_{Tx2} 740 and the distance to the array 701 is d_{Rx2} 742. FIG. 7C depicts the active transducer elements of both the left sub-aperture 724 and the right sub-aperture 726 of the linear transducer array 701 during operations (i) and (ii) that simultaneously transmit both plane waves. Additional discussion configuration and directivity of a narrow-strip acoustic linear transducer array such as the narrow-strip acoustic linear transducer array 701 described with respect to FIGS. 7A-7C can be found in Selfridge, A., Kino, G., and Khuri-Yakub, B., “A Theory for the Radiation Pattern of a Narrow-Strip Acoustic Transducer,” Appl. Phys. Lett. 37, 35 (1980), which is hereby incorporated by reference in its entirety.

FIG. 8 depicts the voltage pulse with time (transmit) delays applied to the transducer elements of the left subaperture to direct the plane wave at the cross-propagation angle, according to an embodiment. In FIG. 8, the linear transducer array 701 includes an aperture of sixteen (16) transducer elements 722 (e₁-e₈ and e₁₀-e₁₇) that are active during an xAM pulse sequence. The aperture includes a left subaperture 824 with a first set of transducer elements, e₁-e₈, and a right subaperture 826 with a second set of transducer elements, e₁₀-e₁₇. The linear transducer array 701 also includes a virtual bisector 828 between the right subaperture 826 and the left subaperture 824. The transducer element e₉, lying along the virtual bisector 828 between the two subapertures 824, 826 is silent (inactive) during the xAM pulse sequence. In the illustrated example, the cross-propagation angle, θ, is the angle between the plane waves and the x-axis and also between the plane waves and the virtual bisector 828. The illustrated example shows a distance d_{TX2} from the planer wavefront to a point (x₉, z₉) along the virtual bisector 828 and a return distance d_{Rx2} to the array 701. For illustrative purposes, FIG. 8 also depicts the electrical transmission pulse and time delays (d₁, d₂, d₃, d₄, d₅, d₆, d₇, and d₈) used to apply the voltage transmission waveform to each of the transducer elements 722 of the left subaperture 824. The time-delayed activation of the transducer elements 722 causes the generation of a tilted plane wave in a direction that is at cross-propagation angle θ from the x-axis and the virtual bisector 828.

FIG. 7 a schematic diagram of components of a nonlinear ultrasound imaging system 700, according to certain implementations. Some of the components of nonlinear ultrasound imaging system 700 are similar in function to components of nonlinear ultrasound imaging system 500 in FIG. 5 and nonlinear ultrasound imaging system 600 in FIG. 6.

The nonlinear ultrasound imaging system 700 includes a transducer 710 (also referred to herein as a “transducer probe”) having one or more transducer arrays. For illustrative purposes, the transducer 710 is shown during operation transmitting amplitude modulated ultrasound pulse sequence(s) and detecting backscatter echoes from a sample 701. The nonlinear ultrasound imaging system 700 also includes a first digital/analog converter 720 in communication with the transducer 710, which receives signals specifying the angle, voltage, waveform, and other parameters 730 that are communicated to the first digital/analog converter 720 to determine the transmitted waveform, and an amplitude modulated script/user graphical user interface (GUI) 740. The amplitude modulated script 740 is in the form of instructions including imaging parameters that may be input in some cases by an operator via a graphical user interface of an input device. The amplitude modulated script 740 specifies the angle, voltage, waveform, and other transmit parameters 730 that are communicated to the first digital/analog converter 720, which generates voltage pulses sent to the individual transducer elements of the transducer array(s) of the transducer 710. The nonlinear ultrasound imaging system 700 also includes a display 750. As shown, the display 750 can also receive data from the amplitude modulated script/user GUI 740 for display.

The nonlinear ultrasound imaging system 700 also includes a time-gain compensation (TGC) amplifier 760 in communication with the transducer 710, a second analog/digital converter 762 in communication with the TGC amplifier 760, a filter and I/O demodulator 764 connected to the second analog/digital converter 762, a phase inversion operation 766 for inverting the sign of the digital signals received from the left and right sub-aperture transmits in communication with the filter and I/O demodulator 764, an accumulator 768 for summing the inverted left and right sub-aperture signals with the full-aperture signal, local memory 770 in communication with the accumulator 768, a receiving buffer 772 connected to the local memory 770, a beamformer 774 connected to the receiving buffer 772, and an envelope detection module 776 connected to the beamformer 774.

The TGC amplifier 760 is in communication with the transducer 710 to receive backscatter echo signals. The output of the TGC amplifier 760 is received at the second analog/digital converter 762. The output of the second analog/digital converter 762 is received at and filtered and demodulated down to baseband signals by the filter and I/O demodulator 764. The output of the filter and I/O demodulator 764 is received at the phase inversion operation 766 where the sign of the left and right sub-aperture signals is inverted for subtraction from the full-aperture signal. The output of phase inversion operation 766 is received at the accumulator 768. The accumulator 768 stores and retrieves the signals from each of the pulses of an amplitude modulated sequence to subtract the sum of the L/R sub-aperture pulses from the full aperture pulses. The resulting data is communicated to the receiving buffer 772. The output of the receiving buffer 772 is received at the beamformer 774 for beamforming. An example of a beamforming technique is found in Section IV (C). The output of beamformer 774 is received at the envelope detection module 776 for envelope detection. The display 750 is also connected to the envelope detection module 776 to receive the ultrasound image and display parameters from the GUI.

In one implementation, the nonlinear ultrasound imaging system 700 may also include a switch between the transducer 710 and the digital/analog converter 720 and the time-gain compensation (TGC) amplifier 760 to switch between communicating backscatter echo signals to the time-gain compensation (TGC) amplifier 760 and receiving voltage signals to excite the transducer elements communicated from the digital/analog converter 720. In implementations that do not include the switch, the voltage signals used to excite the transducer elements cause a ringdown signal to be appended to the start of the received signal. In this case, the ringdown signal is removed during beamforming.

### III. Nonlinear Ultrasound Imaging Methods

### Coded Excitations

In various embodiments, nonlinear ultrasound imaging techniques involve communicating a transmission signal to ultrasound transducer elements that codes the ultrasound transmissions with multiple frequency or phase cycles. In various examples, the nonlinear ultrasound imaging techniques use a chirp signal, sometimes referred to herein simply as a “chirp,” that is encoded with different frequency cycles. Some examples of types of chirps that can be used include an up-chirp, a down-chirp, a short bandwidth chirp, and a broad bandwidth chirp. With an up-chirp, the instantaneous frequency increase with time. With a down-chirp, the instantaneous frequency decreases with time. In one example, a chirp may have a number of cycles in a range from 12 to 26 MHz. In another example, a chirp may have a number of cycles in a range from 26 to 12 MHz. In another example, a chirp may have a number of cycles in a range from 12 to 20 MHz. An example of a chirp signal with twenty-six (26) frequency cycles that can be used as a transmission signal to encode ultrasound transmissions is illustrated by the ultrasound transmission depicted in the graph shown in FIG. 1B. A chirp may have frequency transitions with various rates such as in a linear transition, an exponential transition, and a log transition. In some example, may have a plurality of frequence cycles with a broadband frequency sweep. Various frequency sweep ranges may be used. Although a chirp is used as an example in various implementations, it would be understood that other types of transmission signals with multiple frequency cycles may be used such as Barker, Golay, or monotones may be used.

Without being bound by theory, it is believed that pore sizes of the protein shells and other physical properties of GVs may affect the nonlinear response. In one embodiment, a chirp or other transmission signal may have a broad band frequency range that targets the nonlinear response of specific categories of acoustic biomolecules. For example, a chirp may have a broad band frequency range of between 12 and 26 MHz to target gas vesicles.

In one embodiment, a nonlinear ultrasound imaging technique uses a Barker code that can code ultrasound transmissions with phase cycles. Various phase cycles may be used. For example, a Barker code having phase cycles of 13 cycles may be used. As another example, a Barker code having phase cycles of 7, or 11 may be used.

### Examples of Amplitude Modulation Imaging Modes

In certain embodiments, nonlinear ultrasound imaging techniques employ an amplitude modulation imaging procedure (e.g., an xAM imaging procedure, pAM imaging procedure, and uAM imaging procedure) to image nonlinear scatterers. The amplitude modulation imaging procedure includes activating different apertures of ultrasound transducers in the transducer arrangement (e.g., transducer array or arrays) to generate at least one amplitude modulation (AM) pulse sequence, each sequence having one or more consecutive pulses with different amplitudes. Each pulse in a pulse sequence forms an acoustic beam along an axis. Each pulse is based on the transmission signal (e.g., chirp) having multiple frequency cycles. During an imaging run, different apertures are activated to sweep an acoustic beam across a field-of-view.

### Denoising Techniques

To suppress noise, the nonlinear ultrasound imaging techniques may include one or more denoising techniques such as matched filtering, mismatched filtering, a targeted receiver aperture technique, or nonlocal means.

### Matched Filtering Example

Matched filtering generally refers to a technique that applies a matched filter to the received signal to extract wavelets from the received signal by cross-correlating the received signal with known wavelets in the transmission signal or another harmonic signal. For example, in the time domain, the impulse response of the matched filter can use the transmission signal as a template by matching the shape of the transmission signal. To maximize the signal to noise ratio of the receive signal, the matched filter may have an impulse response that is a delayed, time-reversed version of the transmission signal. As an illustrated example, the twenty-six (26) cycle chirp in FIG. 1B was used as a template to generate a matched filter that was used for matched filtering-based pulse compression of a received signal to generate the xAM image in FIG. 3D.

### Harmonic Filtering Example

In some cases, a harmonic signal with a frequency range that is different than the frequency range of the transmission signal may be used as a template for generating a matched filter. For example, a harmonic signal with a frequency range higher than the frequency range of the transmission signal may be used to capture higher harmonics which may advantageously avoid artifacts from the skin and other tissues that might be generating backscatter signals at the lower frequencies. In one instance, for example, a matched filter may be based on a template formed from a harmonic signal having a frequency range between 20-31.5 MHz that is higher than the broadband frequency range between 10 to 20 MHz of a chirp transmission signal.

### Mismatched Filtering Example

In some embodiments, nonlinear ultrasound imaging techniques may employ mismatched filtering by applying a filter generated from a template based on the shape of a windowed version of the transmission signal (windowed transmission signal). For example, the transmission signal may be windowed to reduce side lobes. The transmission signal may be windowed using various types of filtered windows such as, for example, Hamming window, a Hanning window, a Kaiser window, a rectangular window, a Flat Top window, a Tukey window, a uniform window, an exponential window, a Blackman window, a Bartlett-Hann window, a Bartlett window, a Blackman-Harris window, a Bohman window, a Chebyshev window, a Gaussian window, a Hann window, a Nuttall's Blackman-Harris window, a Parzen (de la Vallée-Poussin) window, a tapered cosine window, and a triangular window. Various windowing parameters may be used.

### Targeted Receiver Aperture (TRA) Example

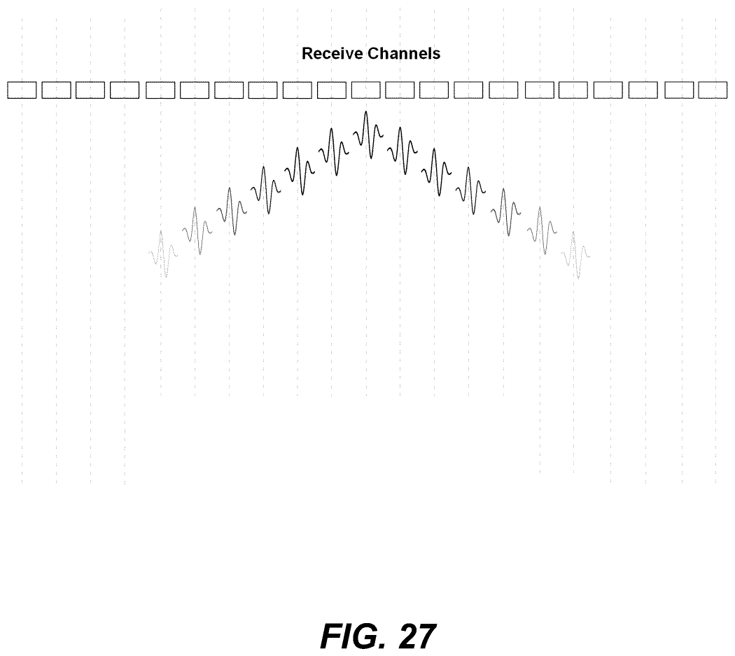

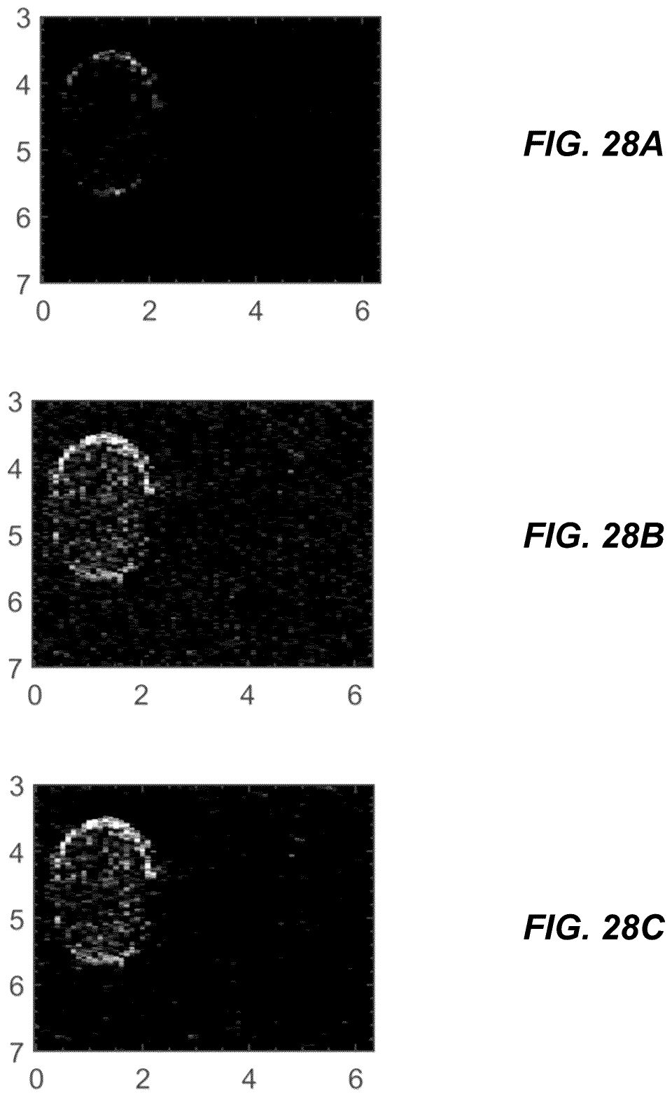

During an imaging procedure, certain ultrasound transducers such as those at the edges of a linear transducers array, may detect weaker backscatter signals mainly due to the distance from the scatterers. FIG. 27 is a schematic drawing illustrating weaker backscatter signals detected by transducer receive elements further away from scatterers primarily due to the receive element directionality, according to an embodiment. In some embodiments, nonlinear ultrasound imaging techniques may include a targeted receiver aperture (TRA) procedure that targets the transducers having high correlation and silences those transducers having low correlation. For example, signals from transducer elements (e.g., first element, e₁, and second element, e₂, and the linear transducer array 701 in FIGS. 7A-7B) at the edges of a transducer array may be suppressed. FIG. 28A is an amplitude modulated image, according to an embodiment. FIG. 28B is an amplitude modulated image obtained using targeted receive aperture procedure, according to an embodiment. FIG. 28C is an amplitude modulated image obtained using targeted receive aperture procedure and denoising procedure, according to an embodiment.

### Example of Nonlinear Ultrasound Imaging Method

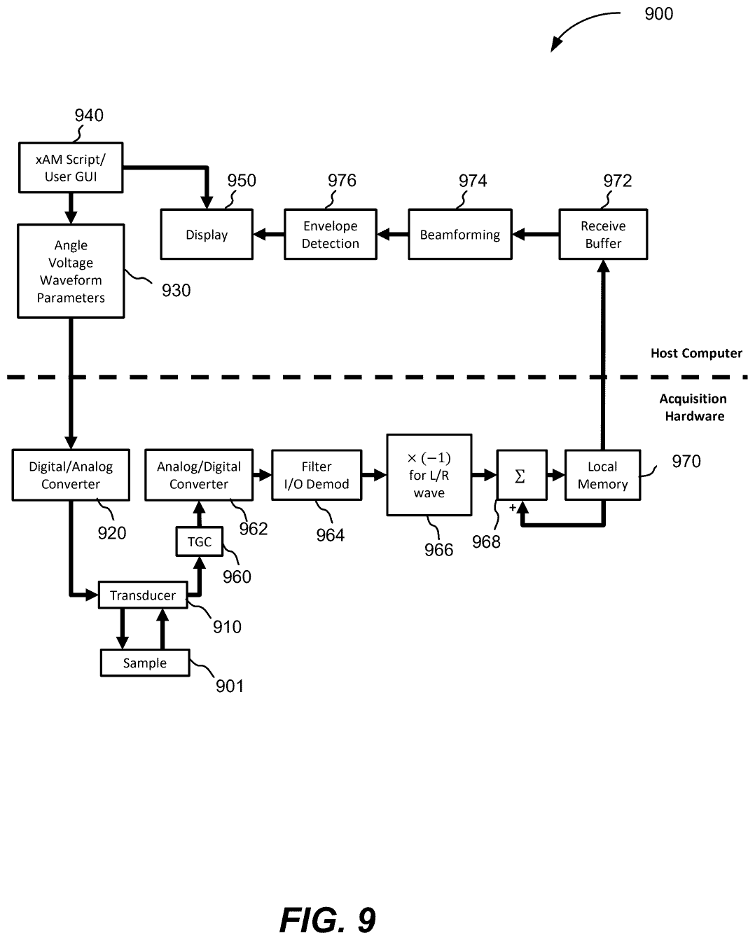

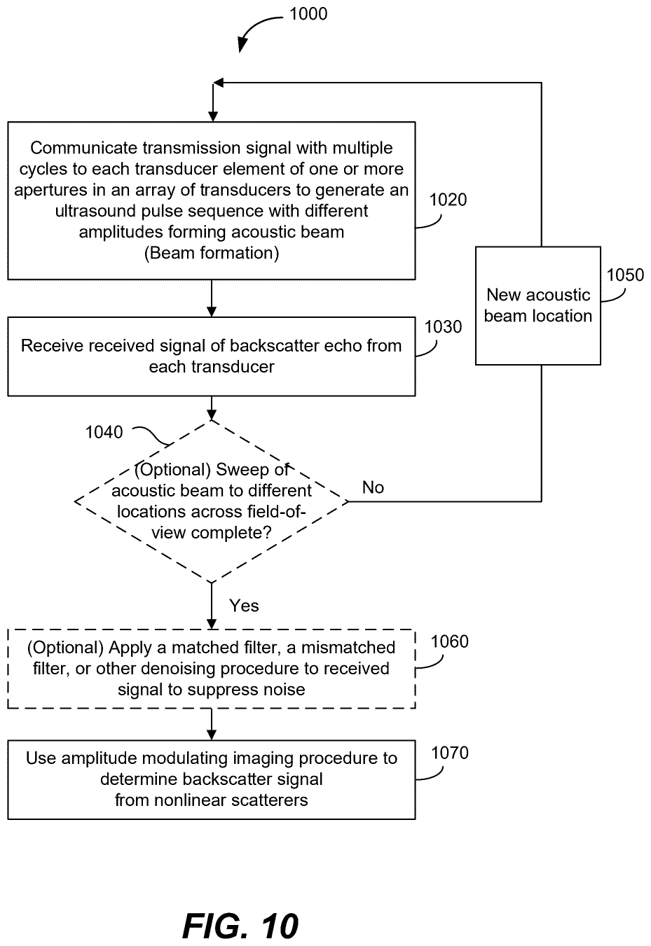

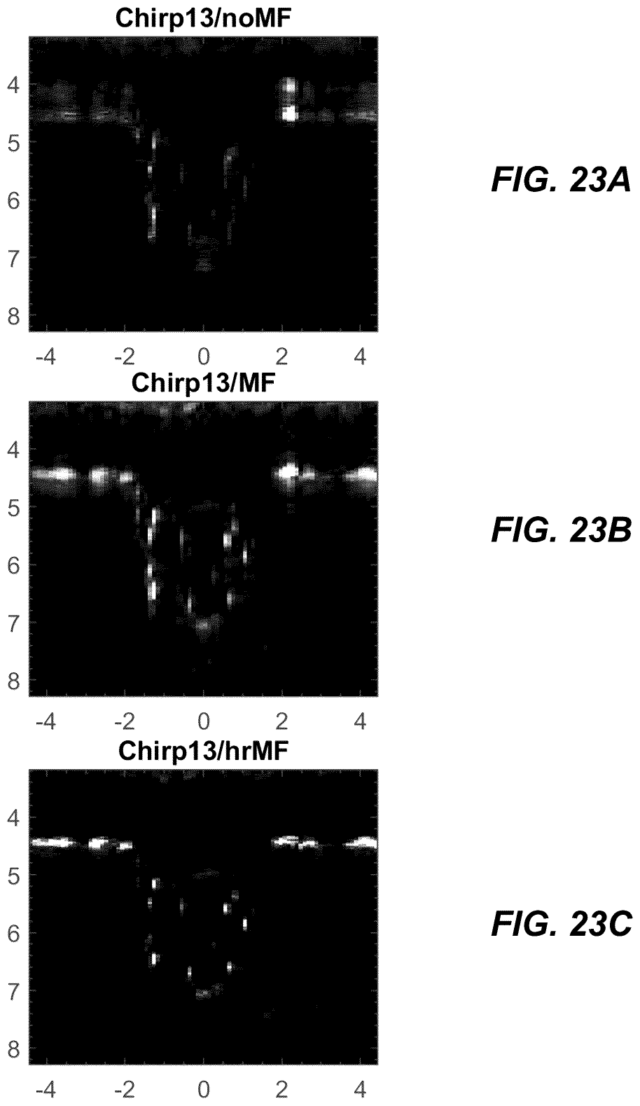

FIG. 10 illustrates a flowchart depicting an example process 1000 for nonlinear ultrasound imaging in accordance with some embodiments. One or more blocks of process 1000 may be executed by one or more processors of one or more computing devices0. An example of such a computing device is shown in and described below in connection with FIG. 23. Alternatively or in addition, one or more blocks of process 1000 may be performed by one or more components of a nonlinear ultrasound imaging system such as system 600 in FIG. 6 or system 900 in FIG. 9. In some implementations, blocks of process 1000 may be executed in an order other than what is shown in FIG. 10. For example, in one implementation, process 1000 may execute block 1070 prior to block 1060. In some embodiments, one or more blocks of process 1000 may be omitted, and/or two or more blocks may be executed substantially in parallel.

Process 1000 can begin at 1010 by causing communication of a transmission signal (voltage transmission waveform) with an applied voltage and multiple cycles, either frequency cycles or phase cycles, to each active transducer element in one or more apertures of an arrangement of transducer elements such as one or more transducer arrays (e.g., linear transducer array 701 in FIGS. 7A-7C). Transmission signals are sent to the active transducer elements in each aperture in a time delayed sequence to generate consecutive coded ultrasound transmissions of an ultrasound pulse sequence with different amplitudes (amplitude modulated ultrasound pulse sequence). The number of active transducer elements at each pulse may be determinative of the pulse amplitude. The time delays and the apodization predominantly determine the shape of the acoustic beam (e.g., Bessel beam, parabolic beam, xAM beam, etc.) formed. The apertures may be different sets of active transducer elements in an arrangement of ultrasound transducer elements.

In some embodiments, the transmission signal may be chirp signal. In one embodiment, the applied voltage and number of cycles in the transmission signal may be selected to image a particular depth of field. In one example, a chirp may have an applied voltage in a range between 1.6V and 30 V. In another example, a chirp may have an applied voltage in a range between 1.6V and 2 V. In one example, a chirp may have a number of cycles in a range from 13 cycles to 40 cycles. An example of a chirp signal with twenty-six (26) frequency cycles that can be used as a transmission signal to encode ultrasound transmissions is illustrated by the ultrasound transmission depicted in the graph shown in FIG. 1B. In some examples, a chirp may have frequence cycles with a broadband frequency sweep. For example, a chirp may have a frequency sweep in a range between 1 MHz and 70 MHz. In another example, a chirp may have a frequency sweep in a range between 12 and 26 MHz.

In one embodiment, the transmission signal may be Barker code. In one example, a Barker code having phase cycles of 13 may be used. As another example, a Barker code having phase cycles of 7 or 11 cycles may be used.

The ultrasound transmissions from the ultrasound pulse sequence generated at block 1020 may be communicated into a tissue being imaged by acoustically coupling the ultrasound transducer elements via an acoustic coupling material (e.g., acoustic gel) and/or a housing encasing the ultrasound transducer elements (e.g., in a probe) to the tissue. Any reflective surfaces and scatterers that lie in the tissue along the propagation path of the ultrasound waves cause reflection and scatter. Each transducer element can convert ultrasound waves from backscatter echoes detected at its face into a backscatter echo signal (received signal). At block 1030, process 1000 may obtain, using the arrangement of transducer elements, a received signal of backscatter echo from each transducer element in the arrangement of arrangement of transducer elements. The process may retrieve the received signals from memory in some cases.

In an alternative embodiment, the process 1000 may use a targeted receiver aperture (TRA) procedure to suppress one or more received signals from targeted transducer element(s) in the arrangement of transducer elements. For example, the process may suppress (e.g. by deactivating elements) weak backscatter signals from transducer elements at the edges of a transducer array. For instance, first transducer element, e₁, and second transducer element, e₂, of the linear transducer array 701 in FIGS. 7A-7B at the edges of a transducer array may be suppressed.

Returning to FIG. 10, at block 1040, process 1000 determines whether the acoustic beam has been swept to the plurality of locations across the field-of-view during the imaging run If it is determined that the acoustic beam has not been swept to all the locations across the field-of-view, the process 1000 increments to a new acoustic beam location (block 1050) and proceeds to block 1020 to activate another set of one or more apertures in the arrangement of transducer elements to generate consecutive coded ultrasound transmissions of another ultrasound pulse sequence forming an acoustic beam at the new location.

If, at block 1040, it is determined that the acoustic beam has been swept to all the locations across the field-of-view, the process 1000 may optionally (denoted by dashed line) apply a matched filter, a mismatched filter, or other denoising procedure to each received signal to suppress noise (block 1060). In some embodiments, the process 1000 may apply a matched filter one or more of the received signals. In one example, the matched filter may be based on a template from the shape of the transmission signal. For instance, the twenty-six (26) cycle chirp in FIG. 1B was used as a template to generate a matched filter that was used for matched filtering-based pulse compression of a received signal to generate the xAM image in FIG. 3D. In another example, the matched filter may be from a template based on the shape of a different signal such as a harmonic signal having a frequency range different from the transmission signal. For instance, a harmonic signal with a frequency range (e.g., 20-40 MHz) higher than the frequency range (e.g., 10 to 20 MHz) of the transmission signal may be used to capture higher harmonics which may advantageously avoid artifacts from the skin and other tissues that might be generating backscatter signals at the lower frequencies. In one instance, for example, a matched filter may be based on a template formed from a harmonic signal having a frequency range between 20-40 MHz that is higher than the broadband frequency range between 10 to 20 MHz of a chirp transmission signal. In other embodiments, the process 1000 may employ mismatched filtering by applying a filter generated from a template based on the shape of a windowed version of the transmission signal (windowed transmission signal). Various types of filtered window may be used (e.g., a Hamming window, a Hanning window, a Kaiser window, a rectangular window, a flattop window, a Tukey window, a uniform window, an exponential window, a Blackman window, etc.)

At block 1070, the process 1000 uses an amplitude modulating imaging procedure to determine the nonlinear backscatter signals from nonlinear scatterers. The nonlinear backscatter signals can be used to generate one or more images of the nonlinear scatterers in the field-of-view. For example, the received signal in the receive buffer may be adjusted based on the transmission delays and then summed across all the receive channels to form a single ray line, which is repeated across the entire aperture of the arrangement of transducer elements (e.g., ultrasound probe).

### Normalized Cross-Correlation Matched Filtering

In some embodiments, nonlinear ultrasound imaging techniques may include a normalized cross-correlation matched filtering technique to retain portions of the received signal with high correlation while suppressing other portions, which may advantageously improve image resolution. In these examples, a normalized correlation value may be determined at every point of the received signal. If the normalized correlation value is lower than a certain threshold, the value at that point is set to zero or nearly zero. In some cases, the threshold may be in a range between 0.2 and 0.9.

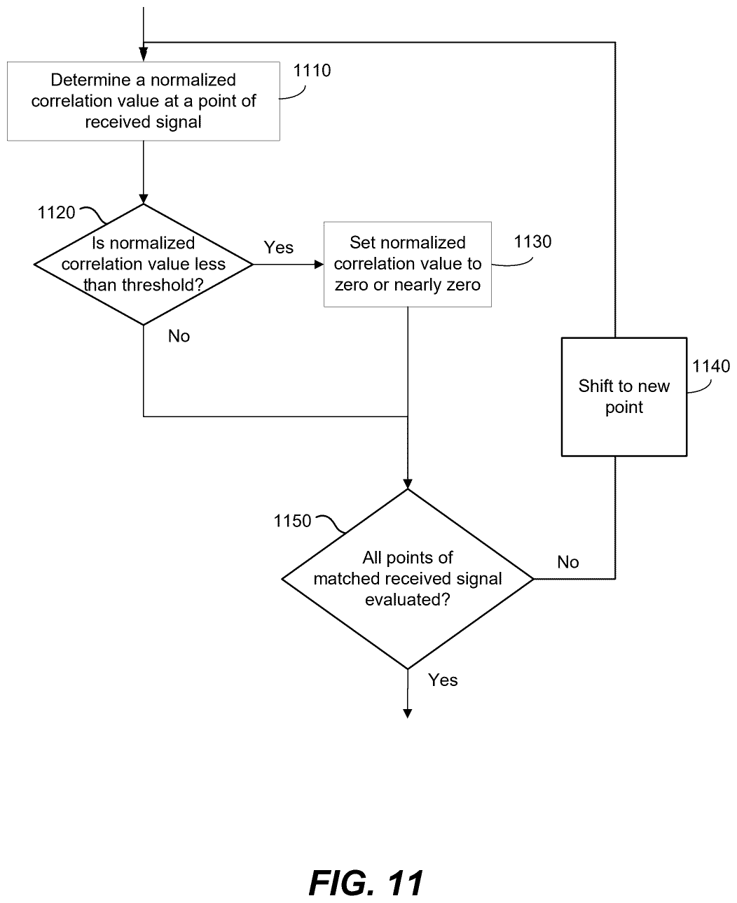

FIG. 11 illustrates a flowchart depicting an example process 1100 of normalized cross-correlation matched filtering in accordance with some embodiments. This normalized cross-correlation matched filtering process 1100 may be an example of block 1040 in FIG. 10. One or more blocks of process 1200 in FIG. 11 may be executed by one or more processors of one or more computing devices. An example of such a computing device is shown in and described below in connection with FIG. 23. In some implementations, blocks of process 1100 may be executed in an order other than what is shown in FIG. 11. In some embodiments, one or more blocks of process 1100 may be omitted, and/or two or more blocks may be executed substantially in parallel.

Process 1100 can begin at 1110 by determining a normalized correlation value at a point of the received signal generated by a transducer element. At 1120, the process 1100 determines whether the normalized correlation value at the point is less than a threshold value (e.g., 0.1, 0.2, 0.3, etc.). If the normalized correlation value is less than the threshold value at the point, the process 1100 can set the normalized correlation value to zero or nearly zero (e.g., 0.01, 0.05, etc.) at that point at block 1130. If the normalized correlation value is greater than or equal to the threshold value at the point, the process 1100 can determine if all the points have been evaluated at block 1150. If all points have not been evaluated, the process 1100 shifts to a new point of the received at block 1140 and returns to block 1110 to determine a normalized correlation value at the new point of the received signal. The resulting normalized correlation values are combined to generate a matched filter that can be applied to the received signal. FIG. 12 is a graph depicted a threshold value curve 1220, a correlation output curve 1230 generated by the process 1110 described in FIG. 11, and a matched filtered signal 1210. The matched filtered signal 1210 was generated by applying a matched filter based on the correlation output curve 1230 to the received signal.

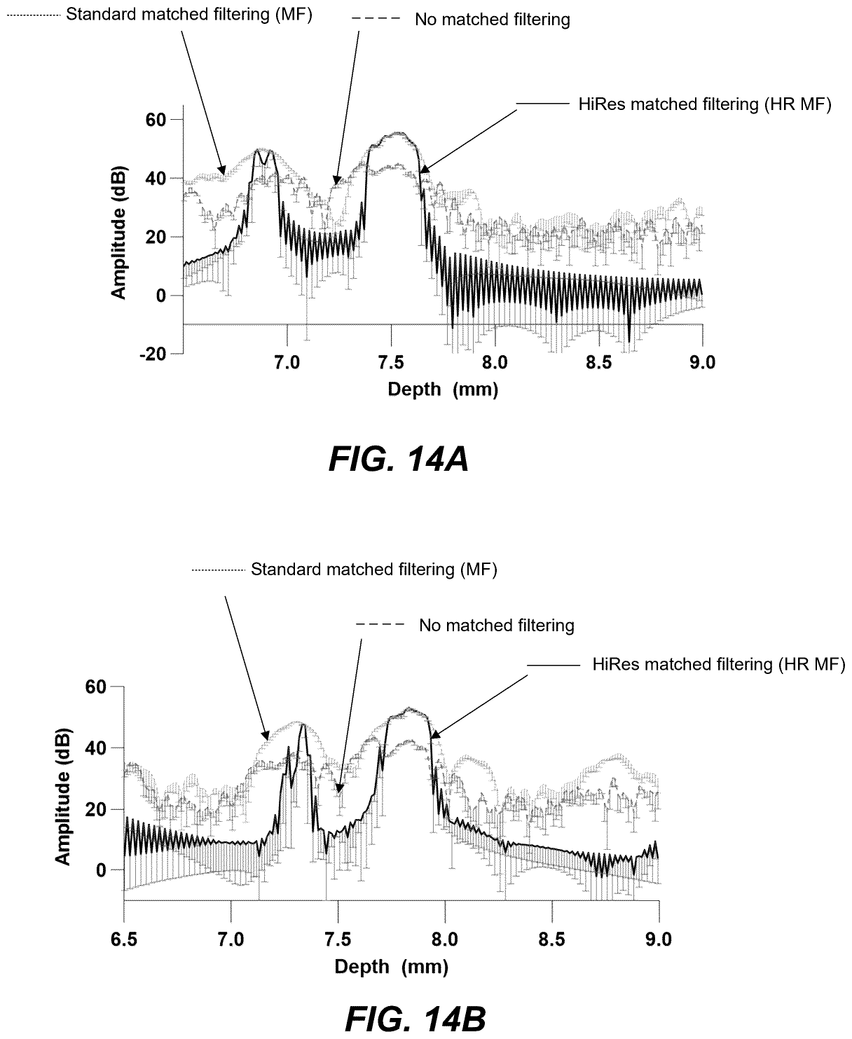

FIG. 13A is an amplitude modulated image obtained using the single pulse excitation at 15.625 MHz center frequency shown in FIG. 1A. FIG. 13B is an amplitude modulated image obtained using a broadband chirp excitation thirteen (13) cycles at 12-24 MHz without matched filtering, according to an embodiment. FIG. 13C is an amplitude modulated image obtained using a broadband chirp excitation thirteen (13) cycles at 12-24 MHz with standard matched filtering that applied a matched filter based on the transmission signal, according to an embodiment. FIG. 13D is an amplitude modulated image obtained using a broadband chirp excitation thirteen (13) cycles at 12-24 MHz with high resolution matched filtering (HR MF) that applied a matched filter based on a normalized cross-correlation matched filtering procedure, according to an embodiment. By comparing the images, the image of the GV well in FIG. 13B obtained with the matched filter based on a normalized cross-correlation matched filtering procedure shows increased image resolution over the image of the GV well in FIG. 13C having standard matched filtering. FIGS. 14A and 14B are graphs showing the details of the results of using (i) a broadband chirp excitation thirteen (13) cycles at 12-24 MHz without matched filtering, (ii) a broadband chirp excitation thirteen (13) cycles at 12-24 MHz with standard matched filtering, and (iii) a broadband chirp excitation thirteen (13) cycles at 12-24 MHz with normalized cross-correlation matched filtering, at a first rayline 1310 and a second rayline 1320 indicated in FIG. 13B. The graphs depict the amplitude at different depths at the two raylines. The results show improvements in relative amplitude and resolution when using normalized cross-correlation matched filtering as compared with no matched filtering and standard matched filtering.

Matched Filtering with Adaptive Multi-Thresholding for Chirp-Based Imaging

In some embodiments, nonlinear ultrasound imaging techniques employ matched filtering with adaptive multi-thresholding for chirp-based imaging. To enhance the detection of point scatterers in chirp-based imaging, certain nonlinear ultrasound imaging techniques implement an adaptive multi-threshold matched filtering approach combined with bandpass filtering for improved signal fidelity and resolution. This adaptive multi-thresholding for chirp-based imaging method includes at least the following operations:

### 1. Bandpass Filtering

In this operation, a bandpass filter is applied to both the input image and the chirp waveform to suppress out-of-band noise and minimize side-lobe artifacts. The filter design targets a frequency range (e.g., fstartf_{\text {start}} fstart to fendf_{\text {end}} fend) normalized by the Nyquist frequency. A 4th-order Butterworth filter or similar filter may be implemented to maintain a flat passband and a steep roll-off. The bandpass filter may be applied iteratively to each column of the input image and to the chirp waveform using the following difference equation:

$$y [ n ] = {b}_{0} x [ n ] + {b}_{1} x [ n - 1 ] + {b}_{2} x [ n - 2 ] + … - {a}_{1} x [ n - 1 ] - {a}_{2} x [ n - 2 ] - … \qquad ( Eqn . 1 )$$

where b and a are the filter coefficients, x [n] is the input signal, and y [n] is the filtered output. The filtering ensures alignment of the spectral content of the image and waveform within the specified frequency range.

### 2. Matched Filtering

Matched filtering is performed by computing the convolution of each column of the filtered image with the conjugate of the chirp waveform. For a column vector x of the filtered image, the matched filter response r is calculated as:

$$r [ n ] = {\sum }_{k = 0}^{L - 1} waveform\_conj \cdot x [ n + k ] \qquad ( Eqn . 2 )$$

where L is the length of the chirp waveform and waveform_conj is its conjugate. The convolution was also calculated for normalized signal, expected to be bound between −1 to 1. This output was stored for subsequent thresholding.

### 3. Adaptive Multi-Thresholding

To distinguish true scatterers from noise and side-lobes, an adaptive multi-thresholding approach operation is implemented. In some cases, threshold values may be predefined in descending order to prioritize stronger correlations. The normalized correlation coefficient result_n for each sliding window is calculated as:

$$result\_n = \frac{\sum w \cdot waveform\_conj}{\sqrt{\sum {w}^{2} \cdot \sum {waveform\_conj}^{2}}} \qquad ( Eqn . 3 )$$

where w is the current window of the signal. For each threshold t, contributions to the cumulative response were computed if result_n>t. The contribution weight is defined as:

$$weight = {( \frac{t}{max ( threshold\_factors )} )}^{2} \qquad ( Eqn . 4 )$$

and the narrowing factor is calculated as:

$$narrowing\_factor = 1 + {( result\_n - t )}^{2} \qquad ( Eqn . 5 )$$

The weighting and narrowing factors may ensure that higher thresholds dominate the cumulative result. The cumulative response for each sample is given by:

$$cumulative\_result = {\sum }_{t} weight \cdot result \cdot narrowing\_factor \qquad ( Eqn . 6 )$$

The cumulative result is normalized by the total weight of the contributing thresholds to ensure balanced contributions.

In some cases, the matched filter response matrix is refined by applying the cumulative thresholding logic across all columns of the image. Responses below all thresholds are discarded, while those exceeding at least one threshold are enhanced based on their correlation strength. This method can ensure robust detection of point scatterers while suppressing side-lobes and noise, balancing weak signal retention and axial resolution. This method may be particularly effective with chirp-based imaging where side-lobes can obscure low-correlation scatterers.

In one embodiment of the nonlinear ultrasound imaging method with matched filtering with adaptive multi-thresholding for chirp-based imaging, instead of using static threshold values, a dynamic scaling factor based on local statistics is used.

In one embodiment of the nonlinear ultrasound imaging method with matched filtering with adaptive multi-thresholding for chirp-based imaging, a matrix-based operation is implemented to speed up computation.

In one embodiment of the nonlinear ultrasound imaging method with matched filtering with adaptive multi-thresholding for chirp-based imaging, normalize the cumulative result by the total weight to balance contributions, which otherwise could lead to emphasis on contributions from lower thresholds that may dominate under certain conditions.

### Bessel Beam

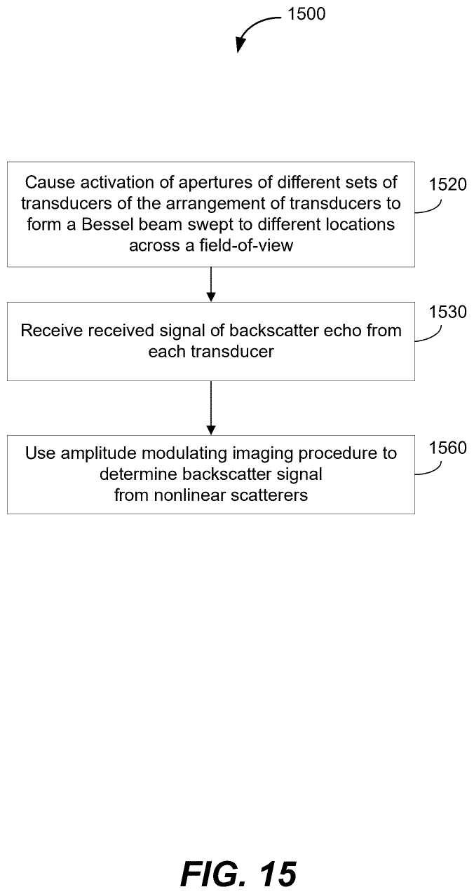

In various embodiments, nonlinear ultrasound imaging techniques implement ultrasound pulses that generate an acoustic Bessel beam scanned across a field-of-view. Implementing a Bessel beam may advantageously improve the depth of field and quality of the images of the acoustic biomolecules. FIG. 15 illustrates a flowchart depicting an example process 1500 for nonlinear ultrasound imaging with at least one Bessel beam, in accordance with some embodiments. One or more blocks of process 1500 may be executed by one or more processors of one or more computing devices. An example of such a computing device is shown in and described below in connection with FIG. 23. Alternatively or in addition, one or more blocks of process 1000 may be performed by one or more components of a nonlinear ultrasound imaging system such as system 600 in FIG. 6 or system 900 in FIG. 9. In some implementations, blocks of process 1500 may be executed in an order other than what is shown in FIG. 15. In some embodiments, one or more blocks of process 1500 may be omitted, and/or two or more blocks may be executed substantially in parallel.

Process 1500 can begin at 1510 by causing communication of transmission signals with an applied voltage and time delays to one or more apertures of different transducer elements in an arrangement of transducer elements. Transmission signals are sent to the active transducer elements in each aperture in a time delayed sequence to generate consecutive ultrasound transmissions of an ultrasound pulse sequence with different amplitudes (amplitude modulated ultrasound pulse sequence). The number and locations of the active transducer elements in each aperture determines the shape of the Bessel beam being formed and the sweeping of the Bessel beam to different locations across the field-of-view. A Bessel beam can be achieving by applying Bessel delays or Bessel apodization or both together. The focal range of the Bessel beam can be controlled by varying the Bessel factor applied to delay computation and/or apodization. In one implementation, the Bessel factor was 1350 and 1200 for delay computation and apodization respectively. For example, an applied voltage of 3V with an aperture of 31 transducer elements having a scaling Bessel factor of 1350 may be used to generate a Bessel beam.

In one embodiment, the process 1500 may also apply a matched filter, a mismatched filter, or other denoising procedure to each received signal to suppress noise. Any of the denoising processes described herein can be used. For example, any of the denoising procedures described with reference to FIGS. 10 and 11 can be used.

The ultrasound transmissions from the ultrasound pulse sequence generated at block 1020 may be communicated into a tissue being imaged by acoustically coupling the ultrasound transducer elements via an acoustic coupling material (e.g., acoustic gel) and/or a housing encasing the ultrasound transducer elements (e.g., in a probe) to the tissue. Any reflective surfaces and scatterers that lie in the tissue along the propagation path of the ultrasound waves cause reflection and scatter. Each transducer element can convert ultrasound waves from backscatter echoes detected at its face into a backscatter echo signal (received signal). At block 1530, process 1500 may obtain, using the arrangement of transducer elements, a received signal of backscatter echo from each transducer element in the arrangement of arrangement of transducer elements. The process 1500 may retrieve the received signals from memory in some cases. In an alternative embodiment, the process 1500 may use a targeted receiver aperture (TRA) procedure to suppress one or more received signals from targeted transducer element(s) in the arrangement of transducer elements.

At block 1560, the process 1500 uses an amplitude modulating imaging procedure to determine the nonlinear backscatter signals from nonlinear scatterers. The nonlinear backscatter signals can be used to generate one or more images of the nonlinear scatterers in the field-of-view. For example, the received signal in the receive buffer may be adjusted based on the transmission delays and then summed across all the receive channels to form a single ray line, which is repeated across the entire aperture of the arrangement of transducer elements (e.g., ultrasound probe).

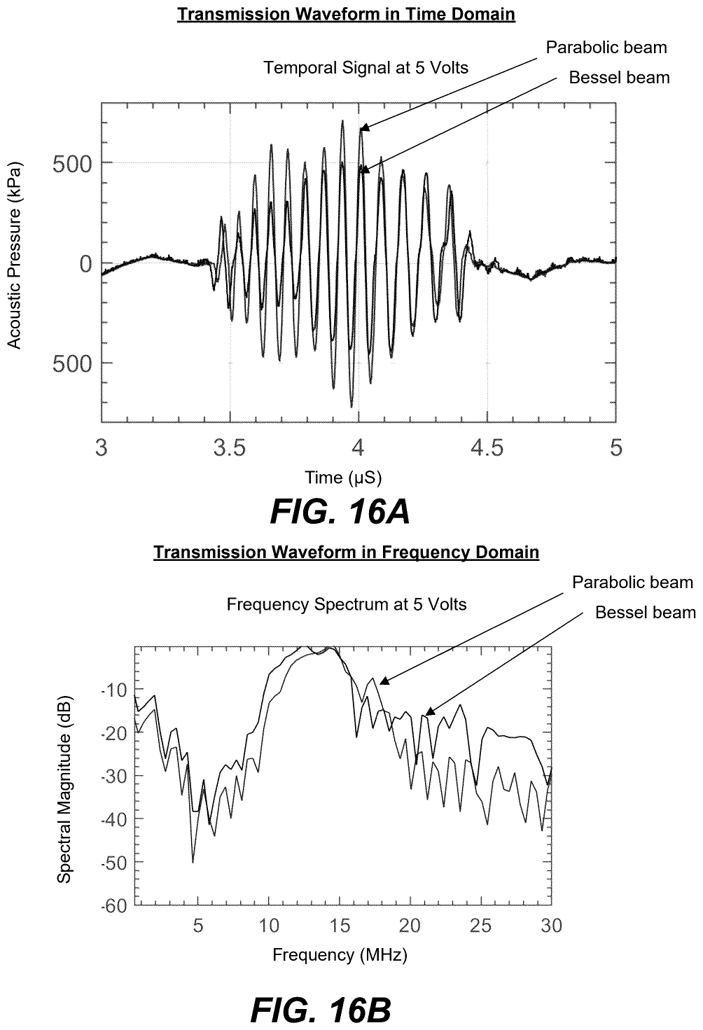

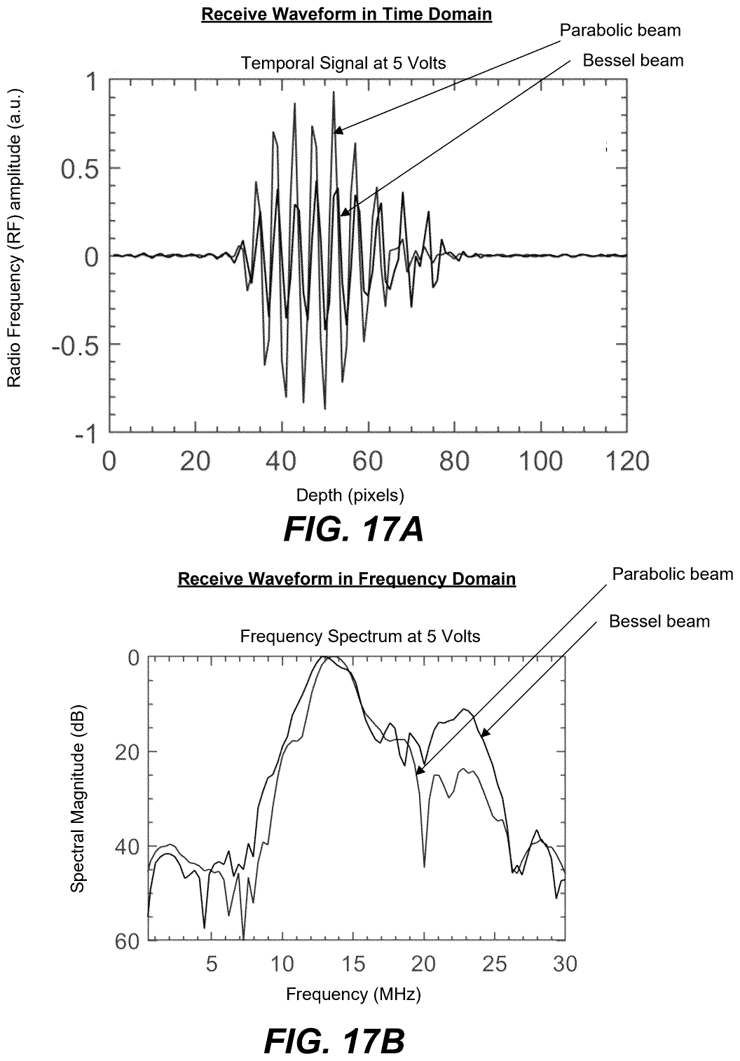

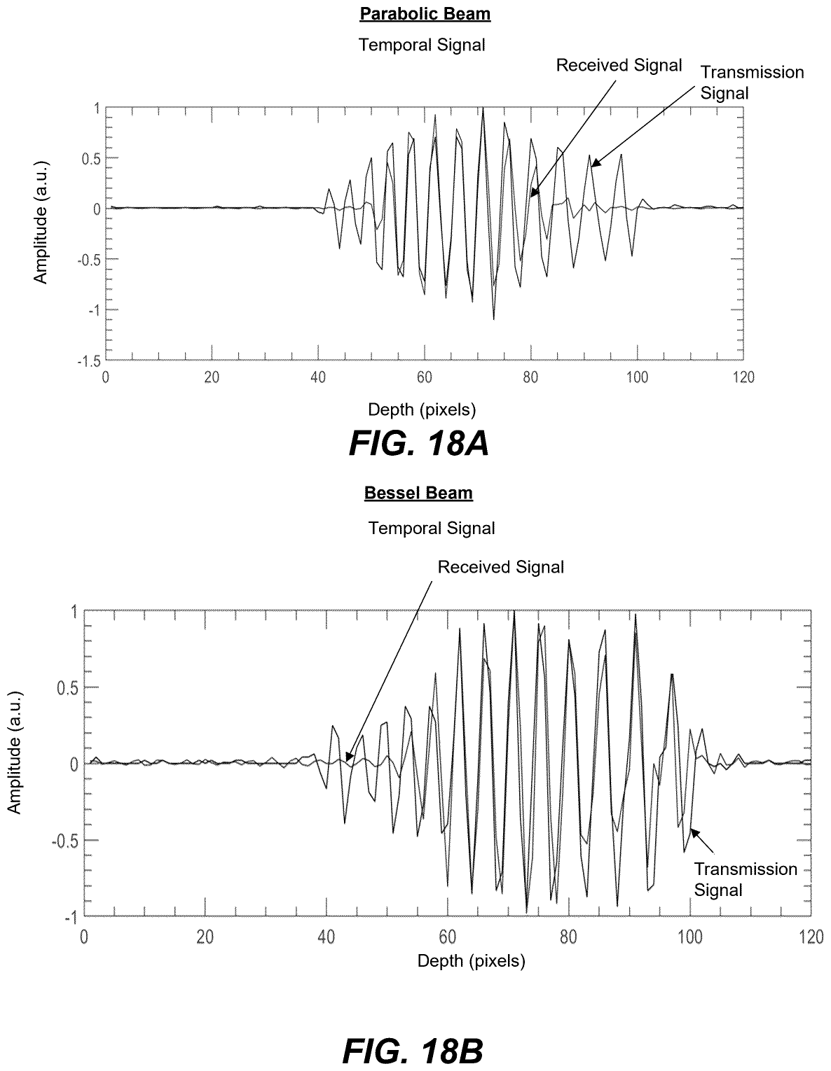

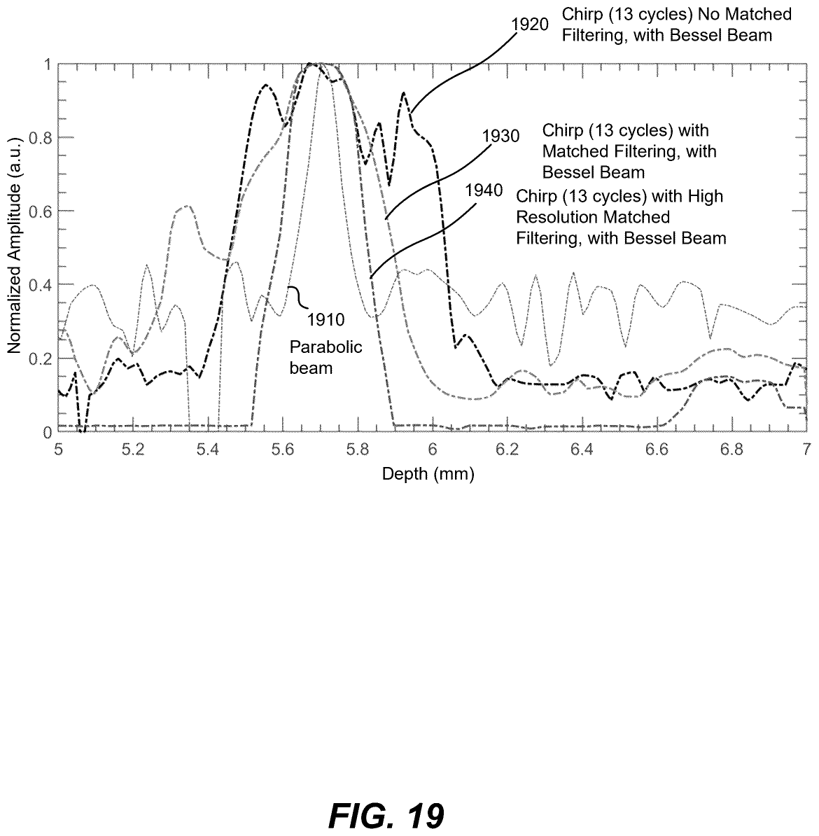

FIG. 16A is graph showing the acoustic pressure of the transmission waveform of a parabolic beam and a Bessel beam in the time domain, according to an embodiment. FIG. 16B is graph showing the acoustic pressure of the transmission waveform of a parabolic beam and a Bessel beam in the frequency domain, according to an embodiment. FIG. 17A is graph showing the acoustic pressure of the received waveform of a parabolic beam and a Bessel beam in the time domain, according to an embodiment. FIG. 17B is graph showing the acoustic pressure of the received waveform of a parabolic beam and a Bessel beam in the frequency domain, according to an embodiment. FIG. 18A is graph showing the received signal overlayed on the transmission signal for a parabolic beam, according to an embodiment. FIG. 18B is graph showing the received signal overlayed on the transmission signal for a Bessel beam, according to an embodiment. FIG. 19 is graph depicting plots of the normalized amplitude at different depths for different images obtained using nonlinear ultrasound methods, according to embodiments. Plot 1810 was obtained using a parabolic beam. Plot 1820 was obtained using a chirp with 13 cycles with a Bessel beam and no matched filtering. Plot 1830 was obtained using a chirp with 13 cycles with a Bessel beam and using standard matched filtering. Plot 1840 was obtained using a chirp with 13 cycles with a Bessel beam and using high resolution matched filtering. The non match filtered data has poorest axial resolution, followed by the conventional match filtering and the best is either single pulse which has poor signal to background ratio, however, in comparison, the HR MF has comparable axial resolution at FWHM, and superior contrast to background ratio.

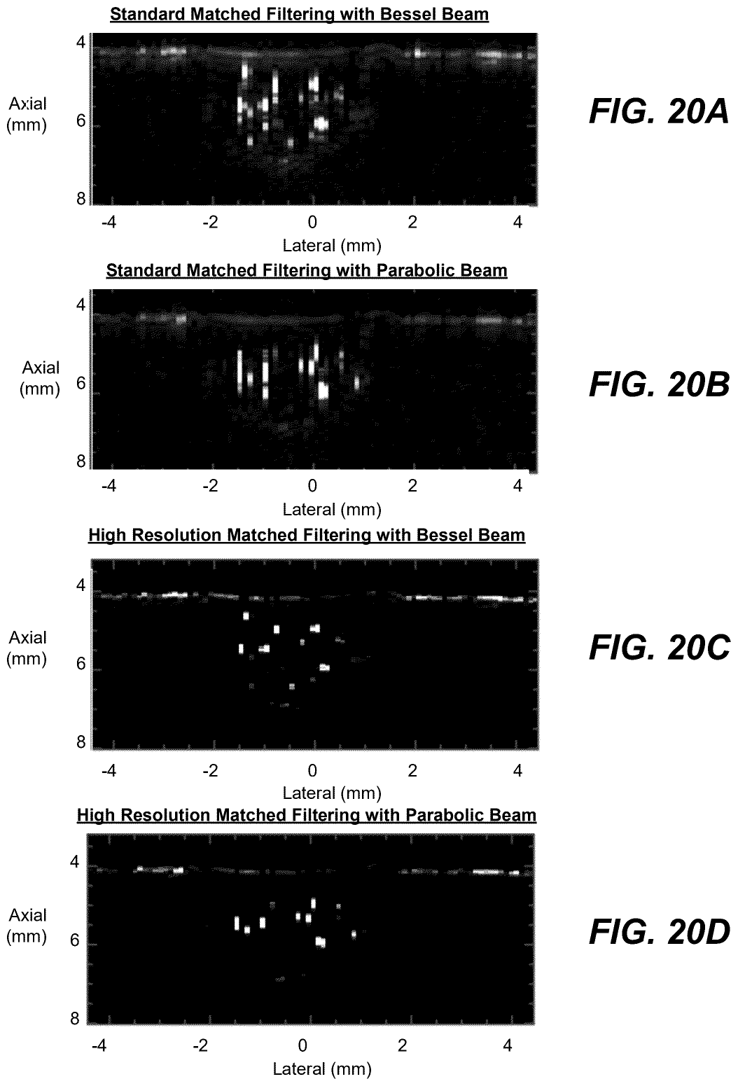

FIG. 20A is an amplitude modulated image obtained by implementing a Bessel beam and standard matched filtering using a template based on the transmission signal, according to an embodiment. FIG. 20B is an amplitude modulated image obtained by implementing a parabolic beam from a parabolic amplitude modulating pulse sequence where standard matched filtering is applied, according to an embodiment. FIG. 20C is an amplitude modulated image obtained by implementing a Bessel beam and high-resolution matched filtering, according to an embodiment. FIG. 20D is an amplitude modulated image obtained by implementing a parabolic beam from a parabolic amplitude modulating pulse sequence where high-resolution matched filtering is applied, according to an embodiment. In comparison, the images in FIGS. 20A and 20C based on Bessel beam implementation provided resolution at greater depth of field than the images in FIGS. 20B and 20D from parabolic beam implementations.

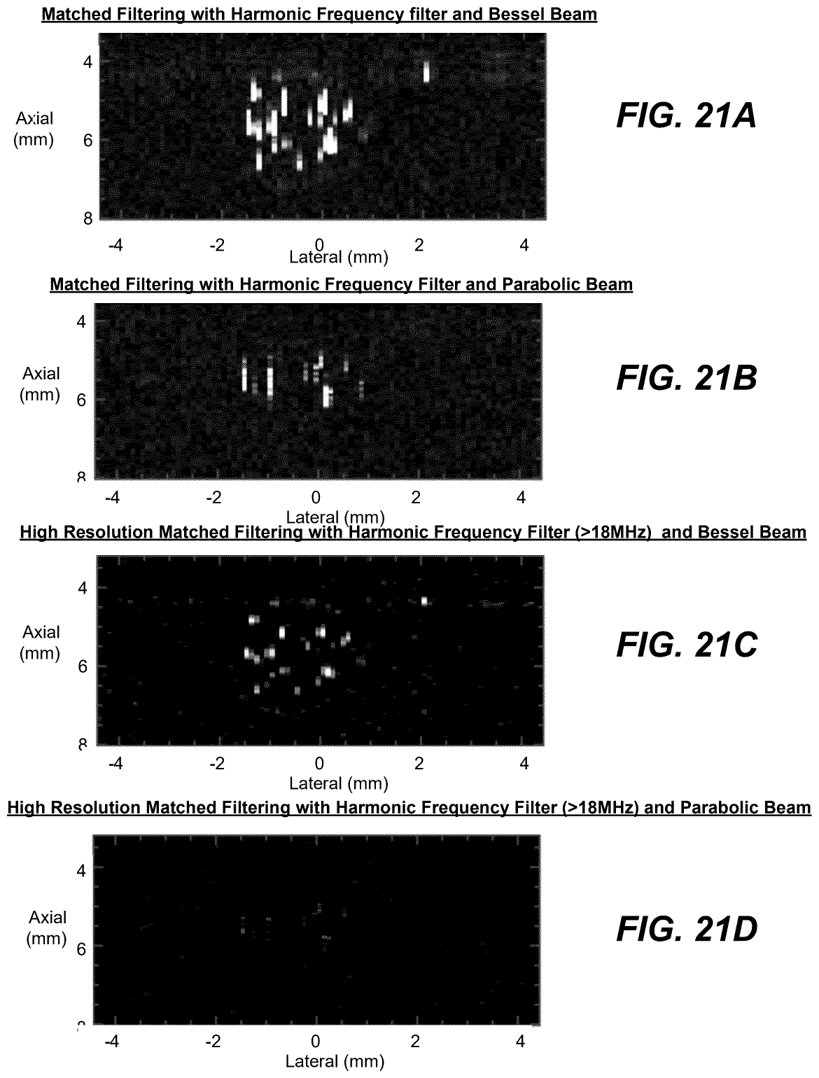

FIG. 21A is an amplitude modulated image obtained by implementing a Bessel beam and matched filtering using a template based on a harmonic signal with a different frequency range than the transmission signal (matched filtering with harmonic frequency filter), according to an embodiment. FIG. 21B is an amplitude modulated image obtained by implementing a parabolic beam from a parabolic amplitude modulating pulse sequence where matched filtering with harmonic frequency filter, according to an embodiment. FIG. 21C is an amplitude modulated image obtained by implementing a Bessel beam and high-resolution matched filtering is applied using a template based on a harmonic signal with a different frequency range than the transmission signal (high resolution matched filtering with harmonic frequency filter), according to an embodiment. FIG. 21D is an amplitude modulated image obtained by implementing a parabolic beam from a parabolic amplitude modulating pulse sequence where high resolution matched filtering with harmonic frequency filter, according to an embodiment. In comparison, the images in FIGS. 21A and 21C based on Bessel beam implementation provided resolution at greater depth of field than the images in FIGS. 21B and 21D from parabolic beam implementations.

### BURST Imaging

In some embodiment, a nonlinear ultrasound imaging method applies frequency-modulated multi-pulse broadband transmissions to collapse-based ultrasound reconstructed with signal templates (BURST) imaging of GVs, to exploit the enhanced cavitation effect associated with extend transmission pulses, while preserving imaging resolution. In BURST imaging, a series of ultrasound images is acquired during which the transmit acoustic pressure undergoes a step-change from a value below the GV collapse threshold to above it. This step-change generates a transient collapse-based signal increase in voxels containing GVs, while the signal from non-GV linear scatterers steps up and persists with the higher applied pressure. The images acquired during this pulse train combine to form a time-series vector for each voxel in the field of view. In BURST signal processing, these vectors are decomposed into weighted sums of template vectors representing the expected signal patterns of GVs, linear scatterers and background noise or offset, allowing for the generation of images specific to each source of signal. BURST imaging may improve the detection sensitivity of GV-expressing cells by isolating the strong signal impulse generated by GVs at the moment of their collapse, while subtracting background linear contrast. In one embodiment, BURST imaging can be combined with AM imaging to improve suppression of background signal.

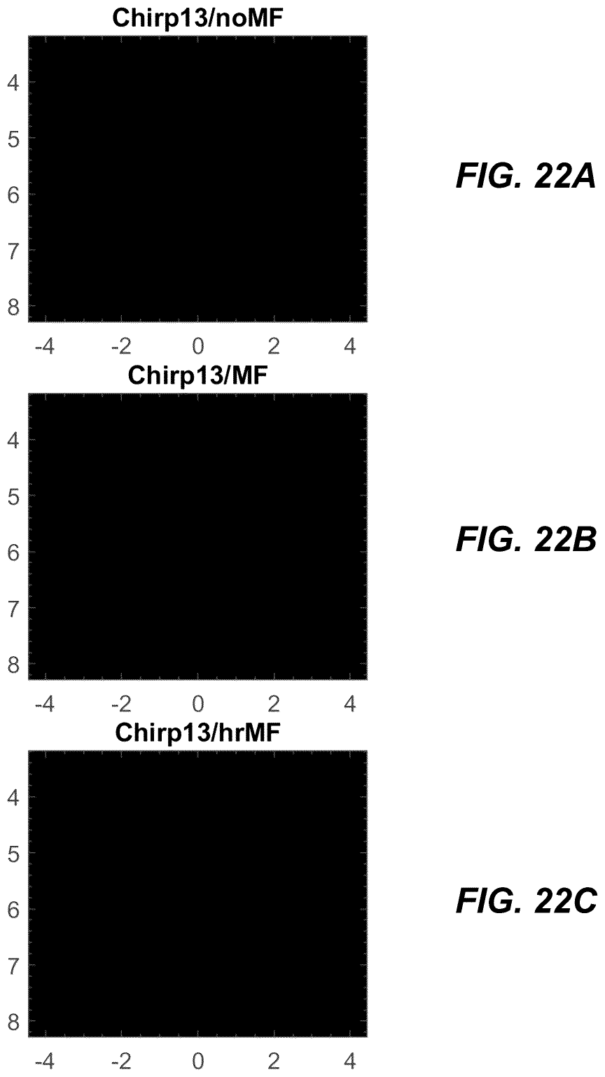

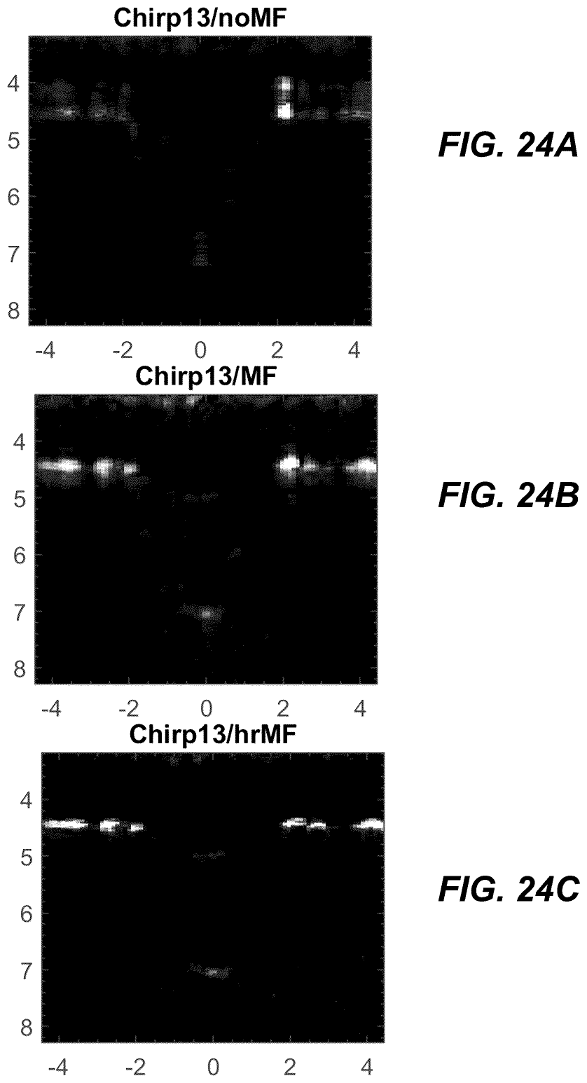

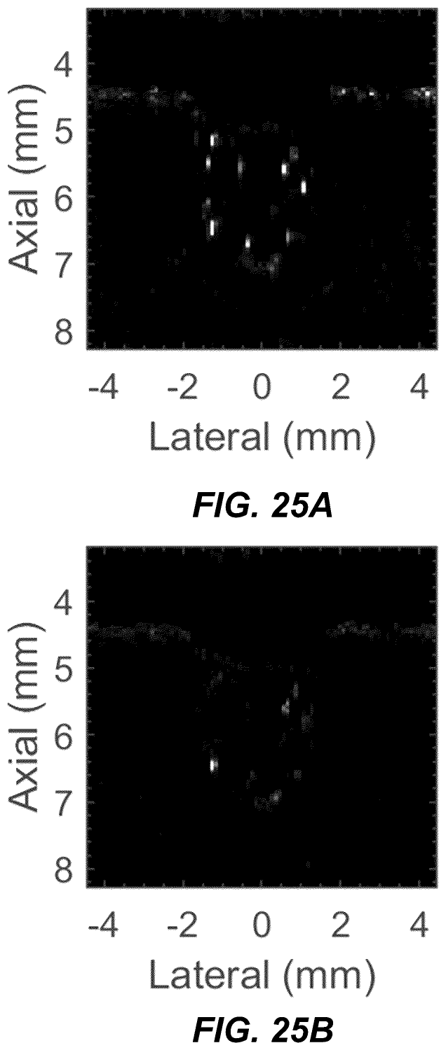

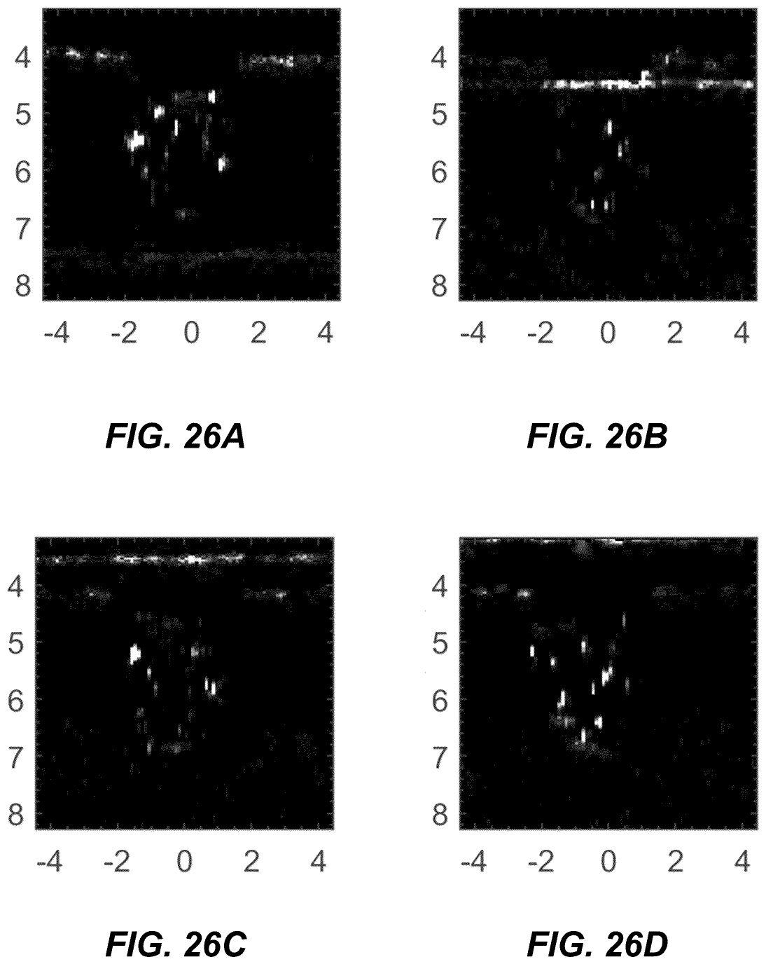

FIG. 22A is a pre-collapse BURST image obtained using a broadband chirp excitation of thirteen (13) cycles without matched filtering, according to an embodiment. FIG. 22B is a pre-collapse BURST image obtained using a broadband chirp excitation of thirteen (13) cycles with standard matched filtering, according to an embodiment. FIG. 22C is a pre-collapse BURST image obtained using a broadband chirp excitation of thirteen (13) cycles with high resolution matched filtering, according to an embodiment. FIG. 23A is a first collapse BURST image obtained using a broadband chirp excitation of thirteen (13) cycles without matched filtering, according to an embodiment. FIG. 23B is a first collapse BURST image obtained using a broadband chirp excitation of thirteen (13) cycles with standard matched filtering, according to an embodiment. FIG. 23C is a first collapse BURST image obtained using a broadband chirp excitation of thirteen (13) cycles with high resolution matched filtering, according to an embodiment. FIG. 24A is a second collapse BURST image obtained using a broadband chirp excitation of thirteen (13) cycles without matched filtering, according to an embodiment. FIG. 24B is a second collapse BURST image obtained using a broadband chirp excitation of thirteen (13) cycles with standard matched filtering, according to an embodiment. FIG. 24C is a second collapse BURST image obtained using a broadband chirp excitation of thirteen (13) cycles with high resolution matched filtering, according to an embodiment. FIG. 25A is a BURST image, according to an embodiment. FIG. 25B is a BURST image, according to an embodiment. FIG. 26A is an example of BURST image of a GV well obtained using a Bessel beam, according to an embodiment. FIG. 26B is an example of BURST image of a GV well obtained using a Bessel beam, according to an embodiment. FIG. 26C is an example of BURST image of a GV well obtained using a Bessel beam, according to an embodiment. FIG. 26D is an example of BURST image of a GV well obtained using a Bessel beam, according to an embodiment.

### IV. Computational Systems

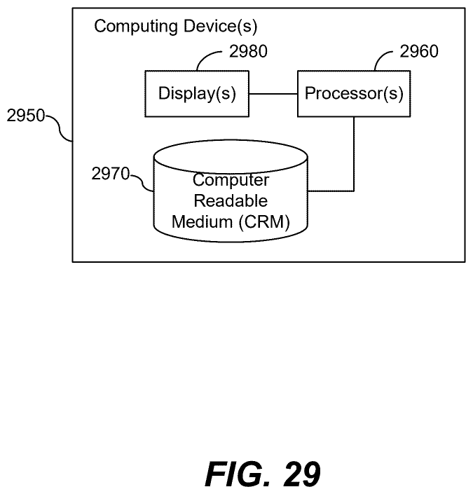

The nonlinear ultrasound imaging techniques of some implementations described above may be implemented using one or more computing devices. FIG. 29 illustrates an example computing device that may be used, e.g., to implement certain blocks of process 1000 of FIG. 10, process 1100 of FIG. 11, and/or process 1500 of FIG. 15 and/or perform functions of system 600 in FIG. 6 or system 900 in FIG. 9.

In FIG. 29, the computing device(s) 2950 includes one or more processors 2960 (e.g., microprocessors), a non-transitory computer readable medium (non-transitory CRM) 2970 in communication with the processor(s) 2960, and one or more displays 2980 also in communication with processor(s) 2960. Processor(s) 2960 is in electronic communication with CRM 2970 (e.g., memory). Processor(s) 2960 is also in electronic communication with display(s) 2980, e.g., to display image data, text, etc. on display 2980. Processor(s) 2960 may retrieve and execute instructions stored on the CRM 2970 to perform one or more functions described above. For example, processor(s) 2960 may execute instructions to perform one or more operations of a nonlinear ultrasound imaging method and/or perform one or more functions of a nonlinear ultrasound imaging system. The non-transitory CRM (e.g., memory) 2970 can store instructions for performing one or more functions or operations as described above. These instructions may be executable by processor(s) 2960. CRM 2970 can also store raw images, e.g., speckle images, or the like.

### Example Embodiments

Embodiment 1: An ultrasound imaging system comprising: an arrangement of transducer elements; and a plurality of apertures of different sets of transducer elements in the arrangement of transducer elements, wherein each transducer element of each aperture is configured to generate an acoustic wave when activated by a transmission signal having a plurality of cycles, wherein acoustic waves generated by each set of transducer elements of each aperture form an acoustic beam along an axis; wherein the arrangement of transducer elements is configured to generate a received signal based on backscatter echo detected in response to the acoustic beam.

Embodiment 2: The ultrasound imaging system of embodiment 1, wherein the cycles are frequency cycles or phase cycles.

Embodiment 3: The ultrasound imaging system of embodiment 1, wherein the cycles are frequency cycles having a broadband frequency sweep.

Embodiment 4: The ultrasound imaging system of embodiment 3, wherein the frequency cycles sweep in a range between 1 and 70 MHz.

Embodiment 5: The ultrasound imaging system of embodiment 3, wherein the transmission signal is (i) a chirp signal or (ii) a Barker code.

Embodiment 6: The ultrasound imaging system of embodiment 1, wherein the acoustic beam is a Bessel beam.

Embodiment 7: The ultrasound imaging system of embodiment 1, wherein the acoustic beam is a cross-amplitude beam, a parabolic amplitude beam, or an ultrafast-amplitude beam.

Embodiment 8: The ultrasound imaging system of embodiment 1, wherein the different sets of transducer elements of the plurality of apertures are configured to generate acoustic beams at different locations across a field of view.

Embodiment 9: The ultrasound imaging system of embodiment 1, further comprising a computing device configured to: cause sequential activation of different sets of transducer elements to generate acoustic beams at different locations across a field of view; and generate an image of nonlinear scatterers in the field of view based on backscatter echo signals generated by the arrangement of transducer elements.

Embodiment 10: The ultrasound imaging system of embodiment 1, wherein the computing device is further configured to matched filter the received signal using a template.

Embodiment 11: The ultrasound imaging system of embodiment 10, wherein the template is based on the transmission signal.

Embodiment 12: The ultrasound imaging system of embodiment 10, wherein the template is based on a harmonic signal.

Embodiment 13: The ultrasound imaging system of embodiment 12, wherein the harmonic signal has a frequency range that is different from a frequency range of the transmission signal.

Embodiment 14: The ultrasound imaging system of embodiment 9, wherein the nonlinear scatterers comprise at least one gas vesicle or at least one microbubble.

Embodiment 15: The ultrasound imaging system of embodiment 1, wherein the arrangement of transducer elements comprises one or more transducer arrays.

Embodiment 16: The ultrasound imaging system of embodiment 1, wherein the one or more apertures comprises: a first aperture configured to transmit a first ultrasound plane wave; and a second aperture configured to transmit a second ultrasound plane wave, wherein the second ultrasound plane wave is noncollinear to the first ultrasound plane wave and axisymmetric to the first ultrasound plane wave about a virtual bisector; wherein the first and second apertures are configured to transmit a pulse sequence by transmitting the first ultrasound plane wave, transmitting the second ultrasound plane wave, and simultaneously transmitting the first and second ultrasound plane waves, wherein the first and second ultrasound plane waves are configured to generate an acoustic pressure that is above a threshold along the virtual bisector.

Embodiment 17: The ultrasound imaging system of embodiment 16, further comprising a computing device configured to: cause activation of different sets of transducer elements to generate the acoustic beam at different locations across a field of view; and for each of the different locations, digitally subtract backscatter echo signals from the first ultrasound plane wave and the second ultrasound plane wave from backscatter echo signals from simultaneous transmission of the first and second ultrasound plane waves to generate an image of nonlinear scatterers in the field of view.

Embodiment 18: An ultrasound imaging method comprising: (i) receiving a transmission signal having a plurality of frequency cycles or phase cycles; and (ii) causing activation of apertures of different sets of transducer elements in an arrangement of transducer elements to generate acoustic waves based on the transmission signal to form an acoustic beam at different locations across a field-of-view.

Embodiment 19: The ultrasound imaging method of embodiment 18, further comprising generating backscatter echo signals based on backscatter echo detected in response to the acoustic waves.

Embodiment 20: The ultrasound imaging method of embodiment 18, wherein the transmission signal has a plurality of frequency cycles having a broadband frequency sweep.

Embodiment 21: The ultrasound imaging method of embodiment 18, wherein the transmission signal has a plurality of frequency cycles sweeping a range between 1 and 70 Mhz.

Embodiment 22: The ultrasound imaging method of embodiment 18, wherein the transmission signal is (i) a chirp signal or (ii) a Barker code.

Embodiment 23: The ultrasound imaging method of embodiment 18, wherein the acoustic beam is one of a Bessel beam, a cross-amplitude beam, a parabolic amplitude beam, or an ultrafast-amplitude beam.

Embodiment 24: The ultrasound imaging method of embodiment 18, wherein causing activation of the apertures comprises: causing activation of a first aperture configured to transmit a first ultrasound plane wave; and causing activation of a second aperture configured to transmit a second ultrasound plane wave, wherein the second ultrasound plane wave is noncollinear to the first ultrasound plane wave and axisymmetric to the first ultrasound plane wave about a virtual bisector; and causing activation of the first and second apertures to simultaneously transmit the first and second ultrasound plane waves, wherein the first and second ultrasound plane waves are configured to generate an acoustic pressure that is above a threshold along the virtual bisector.

Embodiment 25: An ultrasound imaging method comprising: (i) sending a transmission signal having a plurality of frequency cycles or phase cycles to an arrangement of transducer elements; (ii) causing activation of apertures of different sets of transducer elements in an arrangement of transducer elements to generate acoustic waves based on the transmission signal to form an acoustic beam at different locations across a field-of-view; (iii) receiving a received signal from the arrangement of transducer elements with backscatter echo data induced by the acoustic waves; and (iv) generating an image of nonlinear scatterers in the field-of-view based on the received signal.

Embodiment 26: The ultrasound imaging method of embodiment 25, wherein the transmission signal is (i) a chirp signal or (ii) a Barker code.

Embodiment 27: The ultrasound imaging method of embodiment 25, wherein the acoustic beam is one of a Bessel beam, a cross-amplitude beam, a parabolic amplitude beam, or an ultrafast-amplitude beam.

Embodiment 28: The ultrasound imaging method of embodiment 25, further comprising matched filtering the received signal using a template based on the transmission signal.

Embodiment 29: The ultrasound imaging method of embodiment 25, further comprising matched filtering the received signal using a based on a signal having a frequency range that is different from a frequency range of the transmission signal.

Embodiment 30: The ultrasound imaging method of embodiment 25, further comprising matched filtering the received signal using a template based on a signal having a frequency range that is higher than a frequency range of the transmission signal.

Embodiment 31: The ultrasound imaging method of embodiment 25, further comprising: determining a normalized cross-correlation value at each point of the received signal; and if normalized cross-correlation value is less than a threshold, set value at the point of the received signal to zero or nearly zero.

Embodiment 32: The ultrasound imaging method of embodiment 25, further comprising: using a filter window to window the transmission signal to generate a template; and mismatched filtering the received signal using the template based on the windowed transmission signal.

Embodiment 33: The ultrasound imaging method of embodiment 25, wherein the nonlinear scatterers comprise at least one gas vesicle or at least one microbubble.

Embodiment 34: The ultrasound imaging method of embodiment 25, wherein (ii) comprises: causing activation of a first aperture configured to transmit a first ultrasound plane wave; and causing activation of a second aperture configured to transmit a second ultrasound plane wave, wherein the second ultrasound plane wave is noncollinear to the first ultrasound plane wave and axisymmetric to the first ultrasound plane wave about a virtual bisector; and causing activation of the first and second apertures to simultaneously transmit the first and second ultrasound plane waves, wherein the first and second ultrasound plane waves are configured to generate an acoustic pressure that is above a threshold along the virtual bisector.

Embodiment 35: The ultrasound imaging method of embodiment 25, wherein (iv) comprises: for each of the different locations, digitally subtract backscatter echo signals from the first ultrasound plane wave and the second ultrasound plane wave from backscatter echo signals from simultaneous transmission of the first and second ultrasound plane waves to generate an image of nonlinear scatterers in the field of view.

Embodiment 36: The ultrasound imaging method of embodiment 25, wherein (iii) comprises receiving the received signal from a subset of the transducer elements in the arrangement of transducer elements.

Embodiment 37: An ultrasound imaging method comprising causing activation of apertures of different sets of transducer elements in an arrangement of transducer elements to generate acoustic waves forming a Bessel beam swept to different locations across a field-of-view.

Embodiment 38: The ultrasound imaging method of embodiment 37, wherein the activation of the apertures comprises communicating a transmission signal with a plurality of frequency cycles or phase cycles to the arrangement of transducer elements.

Embodiment 39: The ultrasound imaging method of embodiment 25, wherein the nonlinear scatterers comprise an engineered cell expressing gas vesicle the transmission signal is a chirp signal.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C#, C++ or Python, Matlab, or other suitable language/computational software, including low level code, including code written for field programmable gate arrays, for example in VHDL; embedded artificial intelligence computing platform, for example in Jetson. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random-access memory (RAM), a read only memory (ROM), a magnetic media such as a hard-drive or a floppy disk, or an optical media such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. An ultrasound imaging system comprising:
an arrangement of transducer elements; and
a plurality of apertures of different sets of transducer elements in the arrangement of transducer elements, wherein each transducer element of each aperture is configured to generate an acoustic wave when activated by a transmission signal having a plurality of cycles, wherein acoustic waves generated by each set of transducer elements of each aperture form an acoustic beam along an axis;
wherein the arrangement of transducer elements is configured to generate a received signal based on backscatter echo detected in response to the acoustic beam.

2. The ultrasound imaging system of claim 1, wherein the cycles are frequency cycles or phase cycles.

3. The ultrasound imaging system of claim 1, wherein the cycles are frequency cycles having a broadband frequency sweep.

4. The ultrasound imaging system of claim 3, wherein the frequency cycles sweep in a range between 1 and 70 MHz.

5. The ultrasound imaging system of claim 1, wherein the transmission signal is (i) a chirp signal or (ii) a Barker code.

6. The ultrasound imaging system of claim 1, wherein the acoustic beam is one of a Bessel beam, a cross-amplitude beam, a parabolic amplitude beam, or an ultrafast-amplitude beam.

7. The ultrasound imaging system of claim 1, wherein the different sets of transducer elements of the plurality of apertures are configured to generate acoustic beams at different locations across a field of view.

8. The ultrasound imaging system of claim 1, further comprising a computing device configured to:
cause sequential activation of different sets of transducer elements to generate acoustic beams at different locations across a field of view; and
generate an image of nonlinear scatterers in the field of view based on backscatter echo signals generated by the arrangement of transducer elements.

9. The ultrasound imaging system of claim 8, wherein the computing device is further configured for matched filtering the received signal using a template.

10. The ultrasound imaging system of claim 9, wherein the template is based on the transmission signal or based on a harmonic signal having a frequency range different from a frequency range of the transmission signal.

11. The ultrasound imaging system of claim 8, wherein the nonlinear scatterers comprise at least one gas vesicle or at least one microbubble.

12. The ultrasound imaging system of claim 1, wherein the arrangement of transducer elements comprises an ultrasound probe.

13. An ultrasound imaging method comprising:
(i) receiving a transmission signal having a plurality of frequency cycles or phase cycles; and
(ii) causing activation of apertures of different sets of transducer elements in an arrangement of transducer elements to generate acoustic waves based on the transmission signal to form an acoustic beam at different locations across a field-of-view.

14. The ultrasound imaging method of claim 13, further comprising generating backscatter echo signals based on backscatter echo detected in response to the acoustic waves.

15. The ultrasound imaging method of claim 13, wherein the transmission signal has a plurality of frequency cycles having a broadband frequency sweep.

16. The ultrasound imaging method of claim 13, wherein the transmission signal is (i) a chirp signal or (ii) a Barker code.

17. An ultrasound imaging method comprising:
(i) sending a transmission signal having a plurality of frequency cycles or phase cycles to an arrangement of transducer elements;
(ii) causing activation of apertures of different sets of transducer elements in an arrangement of transducer elements to generate acoustic waves based on the transmission signal to form an acoustic beam at different locations across a field-of-view;
(iii) receiving a received signal from the arrangement of transducer elements with backscatter echo data induced by the acoustic waves; and
(iv) generating an image of nonlinear scatterers in the field-of-view based on the received signal.

18. The ultrasound imaging method of claim 17, wherein the acoustic beam is one of a Bessel beam, a cross-amplitude beam, a parabolic amplitude beam, or an ultrafast-amplitude beam.

19. The ultrasound imaging method of claim 17, wherein the transmission signal is (i) a chirp signal or (ii) a Barker code.

20. The ultrasound imaging method of claim 17, further comprising matched filtering the received signal using a template based on the transmission signal.

21. The ultrasound imaging method of claim 17, further comprising matched filtering the received signal using a template based on a harmonic signal having a frequency range that is different from a frequency range of the transmission signal.

22. The ultrasound imaging method of claim 17, further comprising:
determining a normalized cross-correlation value at each point of the received signal; and
if normalized cross-correlation value is less than a threshold, set value at the point of the received signal to zero or nearly zero.

23. The ultrasound imaging method of claim 22, wherein:
the nonlinear scatterers comprise an engineered cell expressing gas vesicle; and
the transmission signal is a chirp signal.

24. The ultrasound imaging method of claim 17, further comprising:
using a filter window to window the transmission signal to generate a template; and
mismatched filtering the received signal using the template based on the windowed transmission signal.

25. The ultrasound imaging method of claim 17, wherein (iii) comprises receiving the received signal from a subset of the transducer elements in the arrangement of transducer elements.
